(19) United States
(12) Patent Application Publication
(10) Pub. No.: US 2011/0028093 A1
(43) Pub. Date: Feb. 3, 2011

(54) Bluetooth Proximity Detection System and Method of Interacting With One or More Bluetooth Devices

(76) Inventors: Shwetak N. Patel, Seattle, WA (US); Gregory D. Abowd, Atlanta, GA (US); Ohad Zeira, Santa Monica, CA (US); Ryan Yong Kim, Torrance, CA (US); Matthew S. Reynolds, Durham, NC (US); Joshua Seal, Marina del Rey, CA (US); Vishwajeet Chatterji, Redondo Beach, CA (US)

Correspondence Address: BRYAN CAVE LLP, TWO NORTH CENTRAL AVENUE, SUITE 2200, PHOENIX, AZ, 85004, US

(21) Appl. No.: 12/845,680

(22) Filed: Jul. 28, 2010

Related U.S. Application Data
(60) Provisional application No. 61/229,074, filed on Jul. 28, 2009.

(51) Int. Cl. H04B 7/00

(52) U.S. Cl. 455/41.2

(57) ABSTRACT

Some embodiments teach an apparatus for determining a proximity of one or more first Bluetooth devices. The apparatus can include: (a) at least one Bluetooth base station with (1) a Bluetooth transmitter configured to transmit one or more service discovery requests to the one or more first Bluetooth devices; and (2) a Bluetooth receiver configured to receive one or more responses from the one or more first Bluetooth devices to the one or more service discovery requests; and (b) a computational module configured to run on one or more processors and further configured to determine one or more approximate distances between the at least one Bluetooth base station and the one or more first Bluetooth devices based on the one or more responses from the one or more first Bluetooth devices. Other embodiments are disclosed.

### CROSS-REFERENCE TO RELATED APPLICATIONS

This application claims the benefit of U.S. Provisional Application No. 61/229,074, filed Jul. 28, 2009. U.S. Provisional Application No. 61/229,074 is incorporated herein by reference.

### FIELD OF THE INVENTION

This invention relates generally to tracking systems and apparatuses, and relates more particularly to systems and apparatuses for determining the proximity of a first Bluetooth device to one or more second Bluetooth devices and methods of determining the same.

### DESCRIPTION OF THE BACKGROUND

Current proximity detection systems use IR (infrared), ultrasound, or RF (radio frequency) sensors to detect the proximity of two tagged objects. These proximity detection systems, however, require people or items to be tagged with an electrical device specifically designed to work with a particular system. Because of the required customized and proprietary hardware, these proximity detection systems can be expensive. For example, one current proximity detection system costs approximately $5,000 for ten sensors. Furthermore, many current proximity detection systems support the detection of the identity of a tagged object in its detectable range and do not provide any ranging measurements. In addition, other disadvantages of the ultrasound and IR proximity detection systems are that the sensors must be exposed and a line-of-sight between must exist between the sensors for the systems to operate.

Some wireless network devices support proximity detection between wireless nodes. These systems can use a received signal strength indicator (RSSI) value to estimate distance between wireless nodes. Similar to the peer-to-peer systems discussed above, these wireless network devices often incorporate expensive, proprietary radios.

Accordingly, a need or potential for benefit exists for an apparatus or system that detects the proximity of similarly tagged objects and that can provide information regarding the distance between the tagged objects without the high costs or other disadvantages of current proximity detection systems.

### BRIEF DESCRIPTION OF THE DRAWINGS

To facilitate further description of the embodiments, the following drawings are provided in which:

FIG. 1 illustrates a block diagram of a proximity detection system, according to a first embodiment;

FIG. 2 illustrates a flow chart for an embodiment of a method of using or interacting with one or more Bluetooth devices, according to the first embodiment;

FIG. 3 illustrates a flow chart for an embodiment of an activity of searching for other Bluetooth devices, according to the first embodiment;

FIG. 4 illustrates a flow chart for an embodiment of an activity of determining the approximate distance;

FIG. 5 illustrates a flow chart for an embodiment of an activity of acquiring and processing additional information about responding Bluetooth devices, according to the first embodiment;

FIG. 6 illustrates a diagram of an exemplary structure with a proximity detection system for interacting with exemplary Bluetooth devices, according to a second embodiment;

FIG. 7 illustrates a block diagram of a Bluetooth base station of the proximity detection system of FIG. 6, according to the second embodiment;

FIG. 8 illustrates a block diagram of a computational device of the proximity detection system of FIG. 6, according to the second embodiment;

FIG. 9 illustrates a flow chart for an embodiment of a method of interacting with one or more Bluetooth devices, according to the second embodiment;

FIG. 10 illustrates a block diagram of a computational device of a proximity detection system for interacting with exemplary Bluetooth devices, according to a third embodiment;

FIG. 11 illustrates a flow chart for an embodiment of a method of interacting with one or more Bluetooth devices, according to the third embodiment;

FIG. 12 illustrates a block diagram of a computational device of a proximity detection system for interacting with exemplary Bluetooth devices, according to a fourth embodiment;

FIG. 13 illustrates a flow chart for an embodiment of a method of interacting with one or more Bluetooth devices, according to the fourth embodiment;

FIG. 14 illustrates a block diagram of a Bluetooth base station of a proximity detection system for interacting with exemplary Bluetooth devices, according to a fifth embodiment;

FIG. 15 illustrates a flow chart for an embodiment of a method of interacting with one or more Bluetooth devices, according to the fifth embodiment;

FIG. 16 illustrates an exemplary embodiment of a computer that is suitable for implementing an embodiment of the proximity detection systems of FIGS. 1, 6, 10, 12, and 14;

FIG. 17 illustrates a representative block diagram of an example of the elements included in the circuit boards inside chassis of the computer of FIG. 17;

FIG. 18 illustrates a graph shows a plot of the maximum range of the tags at varying positions around an individual wearing the tag, according to an embodiment;

FIG. 19 illustrates a graph showing the results of the overall, arm's length-level, room-level, and out-of-range accuracies, according to an embodiment; and

FIG. 20 illustrates a graph showing the results of the different levels of proximity, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Some embodiments teach an apparatus for determining a proximity of one or more first Bluetooth devices. The apparatus can include: (a) at least one Bluetooth base station with (1) a Bluetooth transmitter configured to transmit one or more service discovery requests to the one or more first Bluetooth devices; and (2) a Bluetooth receiver configured to receive one or more responses from the one or more first Bluetooth devices to the one or more service discovery requests; and (b) a computational module configured to run on one or more processors and further configured to determine one or more approximate distances between the at least one Bluetooth base station and the one or more first Bluetooth devices based on the one or more responses from the one or more first Bluetooth devices.

Additional embodiments concern a Bluetooth proximity detection system configured to interact with one or more first Bluetooth devices. The Bluetooth proximity detection system can include: (a) one or more Bluetooth communications modules configured to exchange messages with the one or more first Bluetooth devices using the Bluetooth Service Discovery Protocol; and (b) one or more processing modules configured to run on one or more processors of one or more computer systems. The one or more Bluetooth communications modules can be configured to receive one or more of the messages from the one or more first Bluetooth devices using the Bluetooth Service Discovery Protocol. The one or more processing modules can be further configured to determine one or more approximate distances between the one or more Bluetooth communications modules and the one or more first Bluetooth devices at least in part using the one or of the more messages. The one or more processing modules can be further configured to determine a device type of the one or more first Bluetooth devices using the one or more of the messages.

Still further embodiments concern a method of interacting with one or more first Bluetooth devices. The method can include: transmitting from one or more first Bluetooth base stations one or more service discovery requests to the one or more first Bluetooth devices; receiving in the one or more first Bluetooth base stations one or more responses from the one or more first Bluetooth devices to the one or more service discovery requests; determining one or more first times between transmitting the one or more service discovery requests and receiving the one or more responses; and using the one or more first times to determine one or more approximate distances between the one or more first Bluetooth base stations and the one or more first Bluetooth devices.

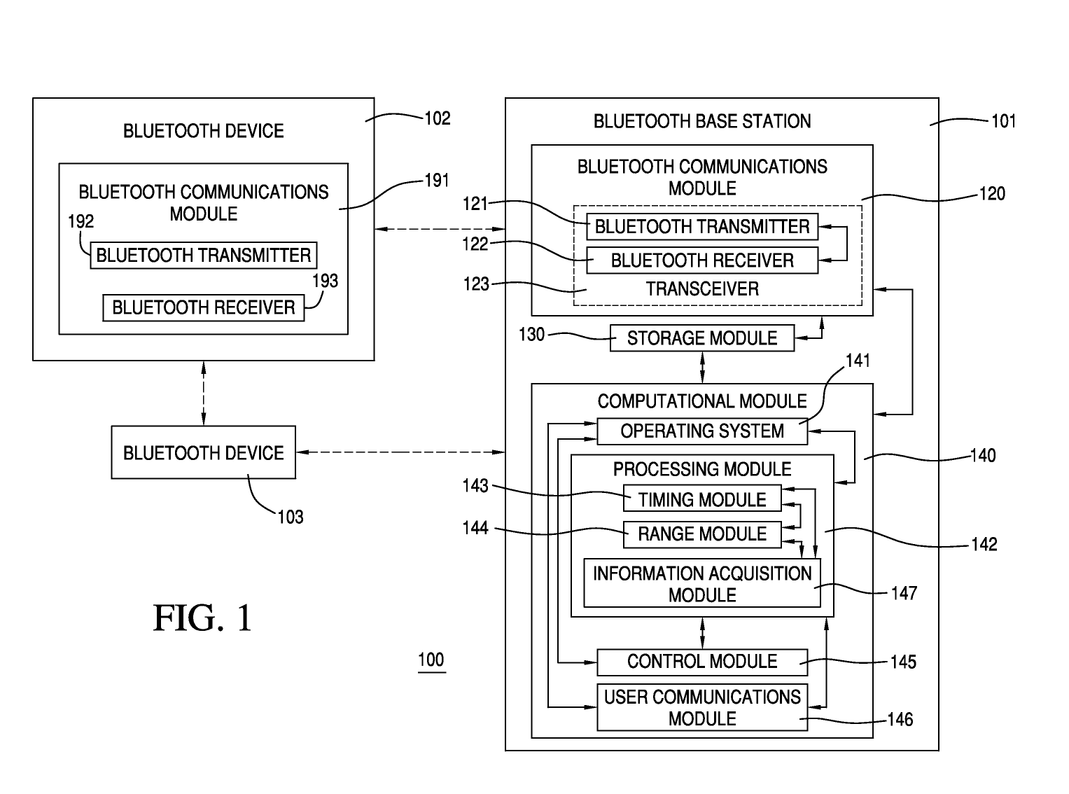

Turning to the drawings, FIG. 1 illustrates a block diagram of a proximity detection system 100, according to a first embodiment. Proximity detection system 100 is merely exemplary and is not limited to the embodiments presented herein. Proximity detection system 100 can be employed in many different embodiments or examples not specifically depicted or described herein.

Proximity detection system 100 can be a general-purpose system configured to determine the proximity between two Bluetooth devices and/or to determine the location of a Bluetooth device within a structure. Proximity detection system 100 uses Bluetooth technology for its implementation and has a number of advantages. The popularity of Bluetooth devices has greatly driven down the cost of its components, which makes it an affordable solution compared to proprietary radio systems. In addition, devices that already incorporate Bluetooth technology, such as mobile phones, laptops, headsets, Personal Digital Assistants (PDAs), and automobiles, interoperate with the system, thus minimizing the number of objects that have to be instrumented or otherwise modified. Proximity detection system 100 can run on a variety of platforms, including personal computers and mobile phones.

The Bluetooth wireless protocol is a standard and a communications protocol for exchanging electrical signals over short distances. In some examples, the Bluetooth wireless protocol refers to the Bluetooth 3.0+HS (High Speed) specification, adopted by the Bluetooth SIG (Special Interest Group) on Apr. 29, 2009. In other examples, the Bluetooth wireless protocol refers to other versions of the Bluetooth wireless protocol, for example, Bluetooth 2.1+EDR (Enhanced Data Rate) adopted by the Bluetooth SIG on Jul. 26, 2007. The Bluetooth 3.0+HS specification and the Bluetooth 2.1+EDR are incorporated herein by reference. In some examples, electrical device communicating via the Bluetooth wireless protocol use a 2.4 GHz (gigahertz) band. In various embodiments, transmitters and receivers that use the Bluetooth wireless protocol can be referred to as Bluetooth transmitters and Bluetooth receivers, respectively.

The Bluetooth wireless protocol includes a Service Discovery Protocol (SDP). The SDP defines the protocols and procedures used by a Bluetooth-enabled electrical device to discover information about other Bluetooth-enabled electrical devices. Under the Bluetooth wireless protocol, exchanges of information under SDP can occur before two Bluetooth devices are paired. Bluetooth pairing is a protocol that occurs when two Bluetooth devices agree to communicate with each other and establish a connection using a specified protocol. For example, using SDP, a first Bluetooth device can discover a Bluetooth device address of another Bluetooth device and also can discover information about the services on the other Bluetooth device, all without pairing the Bluetooth devices together.

Furthermore, under the Bluetooth wireless protocol, two Bluetooth devices can exchange messages using the SDP protocol, even if one or both of the two Bluetooth devices are paired with other Bluetooth devices.

A Bluetooth device address can consist of 6 bytes (e.g., MM:MM:MM:XX:XX:XX). In some cases, the Bluetooth device address is a hardware address that is written in the ROM (read only memory) in the chipset of the device. The first three bytes of this address (e.g., the M-bytes in the above noted example) can identify the manufacturer of the Bluetooth device. In many cases, the last three bytes of this address (e.g., the X-bytes in the above noted example) are at least in part assigned by the manufacturer based on the model of the device. In many cases, it is possible to identify the manufacturer and model of a Bluetooth device based on the Bluetooth device address.

Referring to FIG. 1, in some examples, proximity detection system 100 and/or an apparatus for determining the proximity of Bluetooth devices can include: (a) at least one Bluetooth base station 101; and (b) one or more Bluetooth devices 102 and 103. In various embodiments, Bluetooth device 103 can be similar or identical to Bluetooth device 102. In other examples, proximity detection system 100 includes one or more Bluetooth base stations 101 and not any Bluetooth devices. In still other examples, proximity detection system 100 includes one or more Bluetooth devices 102 and 103, and not any Bluetooth base stations.

In some examples, devices with proximity detection system 100 installed (e.g., mobile phones, laptops, Bluetooth headsets, personal digital assistants, Bluetooth tracking tags, etc.) can determine, for example, three levels of proximity to other Bluetooth devices. In some embodiments, the three levels of proximity equate to roughly within an arm's reach (e.g., within 1-2 meters of the other Bluetooth device), within the same room (e.g., within 3-6 meters of the other Bluetooth device), and unavailable beyond (e.g., beyond 6 meters from the other Bluetooth device). Unlike previous Bluetooth proximity detection systems, Bluetooth devices running proximity detection system 100 do not have to pair with other Bluetooth devices to use proximity detection system 100. Instead, the ranging can be accomplished in proximity detection system 100 using the Service Discovery Profile (SDP) layer. Furthermore, use of proximity detection system 100 also allows for substantially improved battery life over other Bluetooth proximity detection systems because of the lack of pairing.

Bluetooth base station 101 can include: (a) a Bluetooth communications module 120; (b) a storage module 130; and (c) a computational module 140. Bluetooth communications module 120 can include: (a) a Bluetooth transmitter 121; and (b) a Bluetooth receiver 122. In various embodiments, a transceiver 123 can include Bluetooth transmitter 121 and Bluetooth receiver 122. In other examples, Bluetooth communications module includes a separate Bluetooth transmitter 121 and a separate Bluetooth receiver 122.

Bluetooth transmitter 121 can be configured to send one or more service discovery requests to Bluetooth devices 102 and 103. In many cases, Bluetooth transmitter can broadcast messages asking any Bluetooth device within range of the signal of Bluetooth transmitter 121 to respond.

Bluetooth transmitter 121 also can be configured to send the one or more service discovery requests to Bluetooth devices 102 and 103 (and/or other Bluetooth devices) without previously pairing with Bluetooth devices 102 and 103 (and/or other Bluetooth devices). In other systems for determining the proximity of two Bluetooth devices, the two Bluetooth devices must be paired before the distance can be calculated. Bluetooth pairing requires operators of both Bluetooth devices to agree to the pairing and entering of a security code. One of the advantages of proximity detection system 100 is that pairing is not required. The burdensome Bluetooth pairing requirements means that other systems for determining the proximity of two Bluetooth devices that require pairing can usually be used only in very limited circumstances between known devices.

In various embodiments, Bluetooth transmitter 121 can be configured to request a device address from the one or more Bluetooth devices. Bluetooth transmitter 121 also can be configured to request a list of services offered from the one or more Bluetooth devices. Protocols and procedures for requesting a list of services offered by another Bluetooth device is provided for by SDP.

Bluetooth receiver 122 can be configured to receive one or more responses from Bluetooth devices 102 and 103 (and/or other Bluetooth devices) to the service discovery requests. Bluetooth receiver 122 can communicate the one or more responses to computational module 140 in some examples. Bluetooth receiver 122 also can be configured to receive the Bluetooth device addresses and the list of services offered from other Bluetooth devices. In various embodiments, computational module 140 can stored at least parts of the one or more responses in storage module 130. Bluetooth receiver 122 can be configured to receive the one or more responses from Bluetooth devices 102 and 103 (and/or other Bluetooth devices) to the service discovery requests without previously pairing with Bluetooth devices 102 and 103 (and/or other Bluetooth devices).

Bluetooth device 102 can include a Bluetooth communications module 191 with a Bluetooth transmitter 192 and a Bluetooth receiver 193. In some examples, Bluetooth communications module 191 can be configured to exchange messages with Bluetooth communications module 120 using SDP. For example, Bluetooth receiver 193 in Bluetooth device 102 can be configured received the service discovery requests from Bluetooth base station 101. Bluetooth communications module 191 can prepare a response to the service discovery requests, and Bluetooth transmitter 192 can transmit the appropriate response.

Computational module 140 of Bluetooth base station 101 can be configured to run on one or more processors of one or more computer systems. In some examples, computational module 140 can include: (a) a processing module 142; (b) a control module 145; (c) an operating system 141; and (d) a user communications module 146.

Processing module 142 can include: (a) a timing module 143 configured to determine an amount of time between Bluetooth transmitter 121 sending the one or more service discovery requests and Bluetooth receiver 122 receiving the one or more responses; (b) a range module 144 configured to determine the one or more approximate distances between Bluetooth base station 101 and Bluetooth device 102 and/or 103; and (c) an information acquisition module 147 to configured to determine additional information about Bluetooth device 102 and/or 103. In some examples, information acquisition module 147 can use the Bluetooth device address of and/or the list of services offered by the one or more Bluetooth devices to determine a device type of the one or more Bluetooth devices.

Control module 145 can be configured to control Bluetooth communications module 120. In some examples, control module 145 can instruct Bluetooth transmitter 121 when to begin and end transmitting the service discovery requests. Additionally, control module 145 can communicate to timing module 143 when a message is transmitted by Bluetooth transmitter 121 and when a response is received by Bluetooth receiver 122. In other examples, Bluetooth communications module 120 communicates the times to timing module 143. User communications module 146 can be configured to communicate one or more pieces of information to a user of proximity detection system 100.

In various embodiments, operating system 141 can be a software program that manages the hardware and software resources of a computer and/or a computer network. Operating system 141 performs basic tasks such as, for example, controlling and allocating memory, prioritizing the processing of instructions, controlling input and output devices, facilitating networking, and managing files. Examples of common operating systems (OS) include Microsoft® Windows, Mac® OS, UNIX® OS, and Linux® OS.

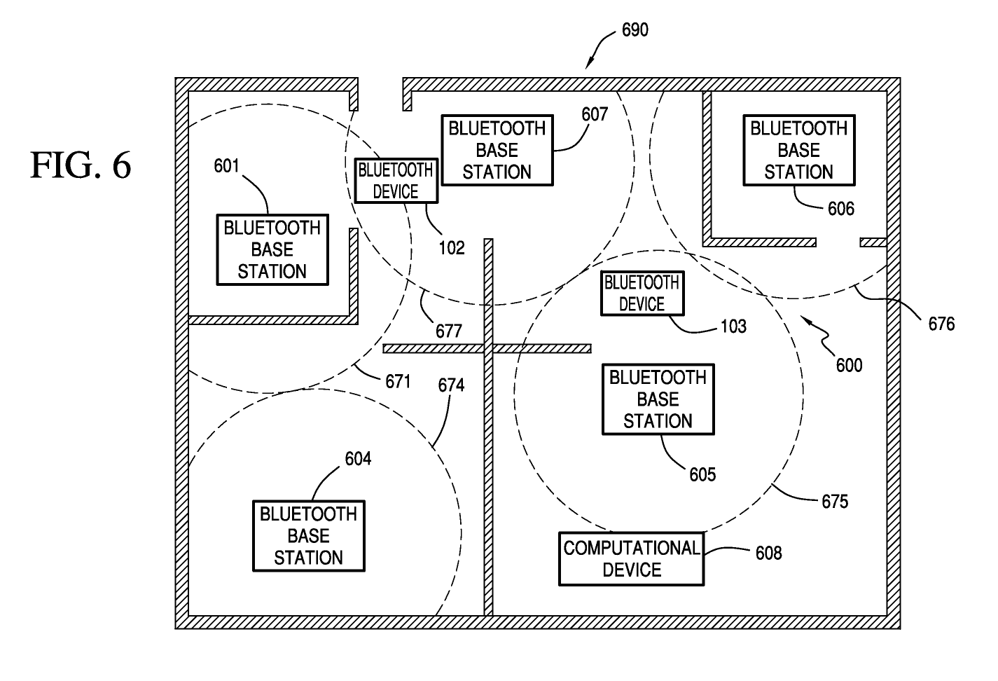

In some examples, Bluetooth base station 101 can be considered at least in part a computer system because it can include one or more processors configured to execute computational module 140. In other examples, proximity detection system 100 includes a separate computer system to execute computational module 140. In these examples, computational module 140 is located in the separate computer system and not in Bluetooth base station 101 (e.g., see proximity detection system 600 in FIGS. 6-8).

“Computer System,” or the like, as used herein, can refer to a single computer, a single server, or a cluster or collection of servers (e.g., a cloud). In many embodiments, the servers in the cluster or collection of servers are interchangeable from the perspective of the users.

In some examples, a single server can include operating system 141, processing module 142, control module 145, and user communications module 146. In other examples, a first server can include a first portion of these modules, and one or more second servers can include a second, possibly overlapping, portion of these modules. In these examples, a computer system can include the combination of the first server and the one or more second servers.

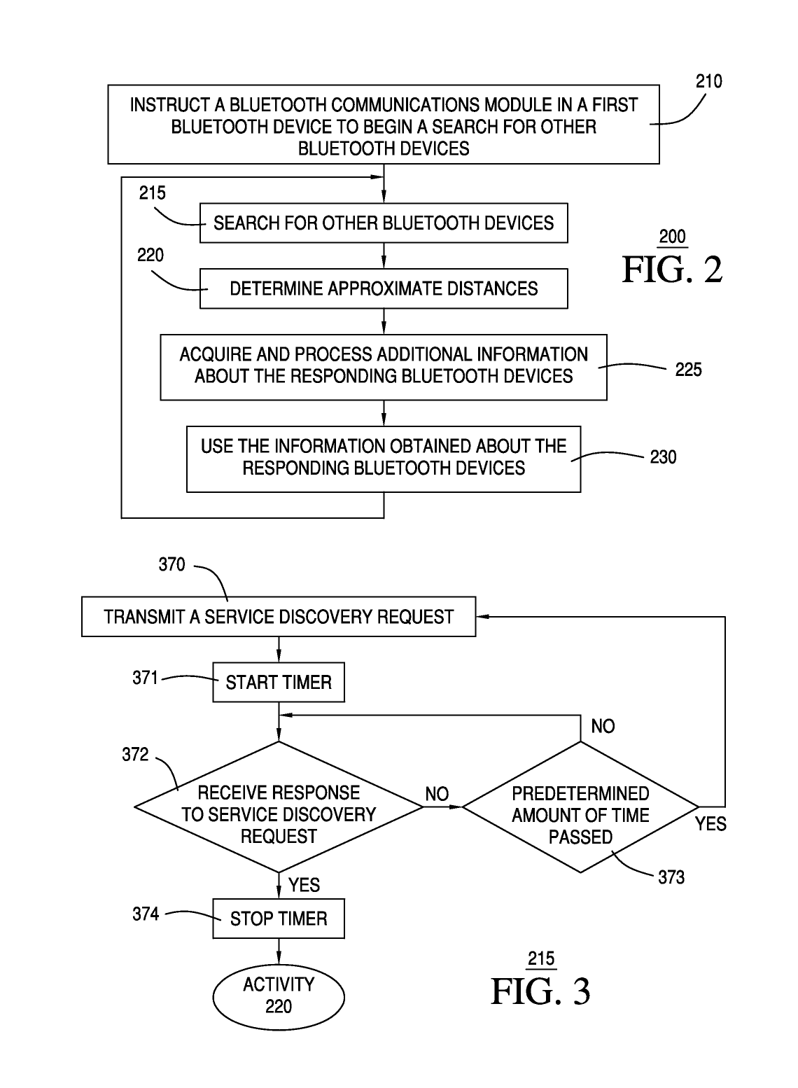

FIG. 2 illustrates a flow chart for an embodiment of a method 200 of using or interacting with one or more Bluetooth devices, according to the first embodiment. In some examples, method 200 can concern a method of determining an approximate distance between two Bluetooth devices. Method 200 is merely exemplary and is not limited to the embodiments presented herein. Method 200 can be employed in many different embodiments or examples not specifically depicted or described herein. In some embodiments, the activities, the procedures, and/or the processes of method 200 can be performed in the order presented. In other embodiments, the activities, the procedures, and/or the processes of the method 200 can be performed in any other suitable order. In still other embodiments, one or more of the activities, the procedures, and/or the processes in method 200 can be combined or skipped.

Referring to FIG. 2, method 200 includes an activity 210 of instructing a Bluetooth communications module in a first Bluetooth device to begin a search for other Bluetooth devices. In some examples, a control module of the first Bluetooth device can instruct a Bluetooth communication module to begin transmitting the one or more service discovery requests. For example, the first Bluetooth device, the Bluetooth communications module, and the control module can be similar or identical to Bluetooth base station 101, Bluetooth communications module 120, and control module 145 of FIG. 1.

Method 200 in FIG. 2 continues with an activity 215 of searching for other Bluetooth devices. FIG. 3 illustrates a flow chart for an embodiment of activity 215 of searching for other Bluetooth devices, according to the first embodiment.

Referring to FIG. 3, activity 215 begins with a procedure 370 of transmitting a service discovery request. In some examples, a Bluetooth transmitter in the Bluetooth communications module can broadcast the service discovery request. In various embodiments, the service discovery request can use the Bluetooth Service Discovery Protocol (SDP). Accordingly, the transmitting of the service discovery request can occur without pairing of the Bluetooth base station and the other Bluetooth devices receiving the service discovery request. Additionally, the Bluetooth base station can transmit a service discovery request, and a Bluetooth device will accept the service discovery request even if this Bluetooth device is already paired with another Bluetooth device. In some examples, the Bluetooth transmitter can be similar or identical to Bluetooth transmitter 121 of FIG. 1.

Subsequently, activity 215 of FIG. 3 includes a procedure 371 of starting a timer. In some examples, the timer is started concurrently with or immediately after transmitting the service discovery request. In some examples, a timing module can start a timer. In other examples, starting the timer can involve recording the time that the service discovery request was transmitted. In many embodiments, the timing module can be similar or identical to timing module 143 of FIG. 1.

Activity 215 of FIG. 3 continues with a procedure 372 of determining whether a response to the service request was received. In some examples, a Bluetooth receiver in the Bluetooth base station can receive a response from a single Bluetooth device to the service discovery request. In other examples, the Bluetooth receiver can receive responses from two or more other Bluetooth devices. In various embodiments, the response(s) to the service discovery request can use the Service Discovery Protocol. Accordingly, the receiving of the response(s) to the service discovery request can occur without pairing of the Bluetooth base station and responding Bluetooth devices. In various embodiments, the Bluetooth receiver can be similar or identical to Bluetooth receiver 122 of FIG. 2.

Moreover, the Bluetooth base station can receive a response from a Bluetooth device (and the Bluetooth device can send a response) even if this Bluetooth device is paired with another Bluetooth device. For example, if a Bluetooth-enabled cellular telephone is paired with a Bluetooth headset, the Bluetooth base station can still receive responses from both the Bluetooth-enabled cellular telephone and the Bluetooth headset.

If no response to the service discovery request is received in procedure 372, the next procedure in activity 215 of FIG. 3 is a procedure 373 of determining if a predetermined amount of time has passed. If the predetermined amount of time has passed, procedure 370 of transmitting a service discovery request is repeated. If the predetermined amount of time has not passed, procedure 372 is repeated. In some examples, the predetermined amount of time is one second. In other examples, the predetermined amount of time can be ten seconds, one minute, or five minutes.

If one or more responses to the service discovery request are received, the next procedure in activity 215 of FIG. 3 after procedure 372 is a procedure 374 of stopping the timer. In some examples, the timer module can stop the timer. In some examples, stopping the timer can involve the timing module or the Bluetooth communications module recording the time at which each of the response(s) to the service discovery request was received. After procedure 374, activity 215 is complete and the next activity is an activity 220.

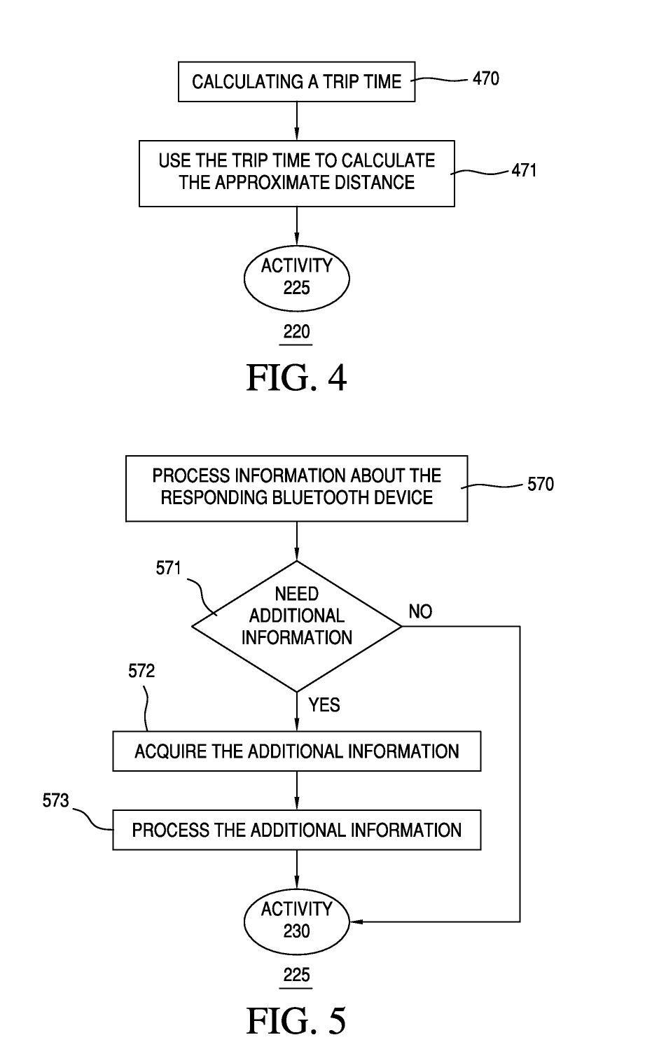

Next, method 200 of FIG. 2 includes the activity 220 of determining an approximate distance. In activity 220, the approximate distances between the Bluetooth base station and responding Bluetooth devices can be determined. FIG. 4 illustrates a flow chart for an embodiment of activity 220 of determining the approximate distance.

Referring to FIG. 4, activity 220 begins with a procedure 470 of calculating a trip time. In various embodiments, the timing module can calculate a trip time. In some examples, the trip time for each of responding Bluetooth device can be the round-trip time. That is, the trip time can be an amount of time between the time when the Bluetooth transmitter sent the service discovery request and the time when the response to the service discovery request was received.

In other examples, the trip time for each of the responding Bluetooth devices can be the one-way trip time. That is, the trip time can be the amount of time between the time when the Bluetooth transmitter sent the service discovery request and the time when the response to the service discovery request was received, divided by two. In the same or different examples, the trip time can be calculated using other methods. For example, a method can be used that takes in account the amount of time the responding Bluetooth device needs to prepare and send its response and/or compensates for any barriers or objects between the Bluetooth base station and the responding Bluetooth device that would have slowed or partially blocked the communications.

After calculating the trip time, activity 220 of FIG. 4 continues with a procedure 471 of using the trip time to calculate the approximate distance. Calculating the approximate distance can involve calculating the approximate distance between the Bluetooth base station and each of the responding Bluetooth devices. In some examples, a range module can determine the approximate distance(s). Range module can be similar or identical to range module 144 of FIG. 1.

In some examples, a manufacturer, distributor, or even a user of proximity detection system 100 (FIG. 1) can create a set of correlation data between trip times and distances. That is, correlation data that relate a specific trip time, or a range of trip times to a specific distance or a zone can be saved in storage module 130 (FIG. 1). For example, the correlation data could state that, if the trip time is in the range of A to B, the approximate distance is 0-3 meters, and if the trip time is in the range of C to D, the approximate distance is 3-6 meters. Furthermore, if the trip time is in the range of E to F, the approximate distance is greater than 6 meters. One method of creating correlation data is described below.

In some examples, different sets of correlation data can be calculated for different types and models of Bluetooth transmitters. Different Bluetooth devices can have different transmitter strengths, and different types and thickness of materials surrounding the transmitter, all of which affects the Bluetooth signal strength. Thus, in some examples, different correlation data can be calculated for different types of Bluetooth transmitters. In other examples, a single set of correlation data can be used. The Federal Communication Commission regulates the signal strength of Bluetooth transmitters, and thus, in some examples, the signal strength between different Bluetooth transmitters can be relatively inconsequential, especially given other uncertainties in the determinations.

In many examples, after calculating the approximate distance, the range module can communicate the approximate distance to the control module or a communications module (e.g., user communications module 146 of FIG. 1). After procedure 471, activity 220 is complete.

Referring again to FIG. 2, method 200 of FIG. 2 continues with an activity 225 of acquiring and processing additional information about the responding Bluetooth devices. FIG. 5 illustrates a flow chart for an embodiment of activity 225 of acquiring and processing additional information about responding Bluetooth devices, according to the first embodiment. In other examples, activity 225 can be concurrent with activity 220. In still further examples, activity 225 can occur before activity 220.

Referring to FIG. 5, activity 225 begins with a procedure 570 of processing information about the responding Bluetooth devices. In some examples, processing the information about the responding Bluetooth devices involves processing the Bluetooth address of the responding Bluetooth devices to determine information about the Bluetooth devices. In some examples, an information acquisition module of the computational module can process the information about responding Bluetooth devices. For example, the information acquisition module can be similar or identical to information acquisition module 147 of FIG. 1.

As previously discussed, it can be possible to identify the manufacturer and/or model of a Bluetooth device based on the Bluetooth device address. In some examples, the storage module of the Bluetooth base station (e.g., storage module 130 in FIG. 1) can include data that relates specific ranges of Bluetooth device addresses to specific manufacturers and/or Bluetooth device models. In other examples, the Bluetooth base station can include hardware and/or software that allow it to obtain this information from other systems and/or computers.

Activity 225 of FIG. 5 continues with a procedure 571 of determining if additional information about the responding Bluetooth devices is needed. In some examples, it may not be possible to identify the specific Bluetooth device solely based on its Bluetooth device address. In addition, in some examples, it can be desirable to obtain additional information about the services offered by the responding Bluetooth device. Accordingly, in some situations, the Bluetooth base station can request additional information from the responding Bluetooth devices. If additional information is not needed, activity 225 is complete, and the next activity is activity 230.

If additional information is needed, the next procedure in activity 225 of FIG. 5 is a procedure 572 of acquiring the additional information. For example, if Bluetooth base station cannot identify the responding Bluetooth device based on its Bluetooth device address, Bluetooth base station can acquire additional information. As previously discussed, the additional information available from the responding Bluetooth devices, without pairing, includes the services offered by the responding Bluetooth devices. In procedure 572, a Bluetooth transmitter in Bluetooth base station can request the list of services from the responding Bluetooth devices. A Bluetooth receiver in the Bluetooth base station can receive the list of services from the responding Bluetooth devices. The Bluetooth communications module in the Bluetooth base station can communicate the list of services to the information acquisition module in the Bluetooth base station.

Next, activity 225 of FIG. 5 includes a procedure 573 of processing the additional information. In some embodiments, the information acquisition module can use the list of services along with the Bluetooth device address to attempt to identify the responding Bluetooth device. For example, from the list of services, it may be possible to determine that the responding Bluetooth device is a cellular telephone, a Bluetooth headset, or another Bluetooth accessory. The information acquisition module in the Bluetooth base station can communicate the information it was able to determine about the responding Bluetooth device to the user communication module in the Bluetooth base station. In some examples, the user communication module can be similar or identical to user communications module 146 in FIG. 1. After procedure 573, activity 225 is complete.

Referring again to FIG. 2, the next activity in method 200 is an activity 230 of using the information obtained about the responding Bluetooth devices. In some examples, the user communication module in the Bluetooth base station can communicate the information obtained about the responding Bluetooth device(s) to a user of the Bluetooth base station. In the same or different examples, the information obtained about the responding Bluetooth devices can be stored in a storage device (e.g., storage module 130 in FIG. 1) for later use.

In one embodiment illustrated in FIG. 1, Bluetooth device 102 and or 103 can be a Bluetooth tag attached to another item (e.g., keys, bags, etc.) using a coupling mechanism (e.g., a hook, ring, clip, adhesive, etc.). The Bluetooth base station can be a Bluetooth-enabled cellular telephone, for example. In this example, proximity detection system 100 can be used as a lost item finding system. For example, Bluetooth device 102 can be coupled to a set of keys using a ring. In this example, a person can walk around a structure with their Bluetooth-enabled cellular telephone with proximity detection system 100 enabled. The cellular telephone can communicate to the person (e.g., on a display screen or audibly) its proximity to the Bluetooth tag coupled to the keys. Accordingly, proximity detection system 100 and method 200 (FIG. 2) can be used to find lost objects such as keys.

In another example of a use of proximity detection system 100, a land-based telephone or another device proximate to the land-based telephone can act as a Bluetooth base station. A Bluetooth-enabled cellular telephone can be detected by the Bluetooth base station, and the computational module can arrange for all telephone calls to the Bluetooth-enabled cellular telephone to be forwarded to the land-based telephone. In the same or different example, the lack of detection of a Bluetooth-enabled cellular telephone in the structure could trigger the land-based telephone to forward its telephone calls to the Bluetooth-enabled cellular telephone or another telephone.

In yet another example, a Bluetooth device can be used as input for a gaming system where the movement of the Bluetooth enabled device is tracked using method 200, and these movements are input for a gaming system. In some embodiments, the gaming system can be an augmented reality system where spatially accurate video can be overlaid on top of actual location image. Using method 200 (and/or system 100), a game designer can accurately add in points of interest (e.g. objects or items) in, for example, a structure.

In still a further example, a Bluetooth device can be used to help determine the location of one or more electrical sockets or other objects in a structure. For example, a Bluetooth device can be configured to be plugged into an electrical socket to create a temporary Bluetooth beacon at that electrical socket. One or more Bluetooth base stations can detect the Bluetooth device and the location of the electrical socket can be identified and/or its position in the structure determined. In the same or different examples, the Bluetooth device can be coupled to an object. A switch on the Bluetooth device can be activated, which enables the Bluetooth communication module of the Bluetooth device. One or more Bluetooth base station can then detect the Bluetooth device and the location of the object can be identified and/or its position in the structure determined.

In yet another example, method 200 (and/or system 100) can be used to help determine if a Bluetooth device is coupled to an electrical charger or plugged into an electrical power infrastructure of a structure. For example, if a system is tracking electrical power usage in a structure, a change in location of a Bluetooth device can imply in some situations that the Bluetooth device is not longer electrically coupled to the electrical infrastructure of the structure. For example, a system tracking energy used in a structure could detect a decrease in the electrical power usage at approximately the same time that a Bluetooth device is moved. From these data, the system tracking energy can conclude in some situations that the decrease in electrical power usage was at least in part caused by the Bluetooth device being disconnected from the electrical infrastructure. Also, this information could provide data about the electrical usage profile of a structure. Additional uses of proximity detection system 100 and method 200 (FIG. 2) are described below in relation to FIGS. 6-15.

Returning to FIG. 2, after or concurrent with using the information obtained about the responding Bluetooth device(s), activities 215, 220, 225, and 230 can be repeated until the control module instructs the Bluetooth communications module to stop searching for other Bluetooth devices.

Turning to another embodiment, FIG. 6 illustrates a diagram of an exemplary structure 690 with a proximity detection system 600 for interacting with exemplary Bluetooth devices 102 and 103, according to a second embodiment. Proximity detection system 600 is merely exemplary and is not limited to the embodiments presented herein. Proximity detection system 600 can be employed in many different embodiments or examples not specifically depicted or described herein.

In some examples, proximity detection system 600 can include: (a) Bluetooth base stations 601, 604, 605, 606, and 607; and (b) computational device 608. Bluetooth base stations 601, 604, 605, 606, and 607 can be distributed throughout structure 690. FIG. 6 illustrates one example of a distribution of Bluetooth base stations 601, 604, 605, 606, and 607. Each of Bluetooth base stations 601, 604, 605, 606, and 607 can detect any Bluetooth device located in a circular range around the device. In some examples, the circular range can have a radius of five meters. Discovery zones 671, 674, 675, 676, and 677 (i.e., dotted circles in FIG. 6) illustrate the range of each of Bluetooth base stations 601, 604, 605, 606, and 607, respectively in some examples. In other examples, two or more Bluetooth base stations can be distributed in structure 690 such that the whole interior of structure 690 is within range of at least one of the two or more Bluetooth base stations.

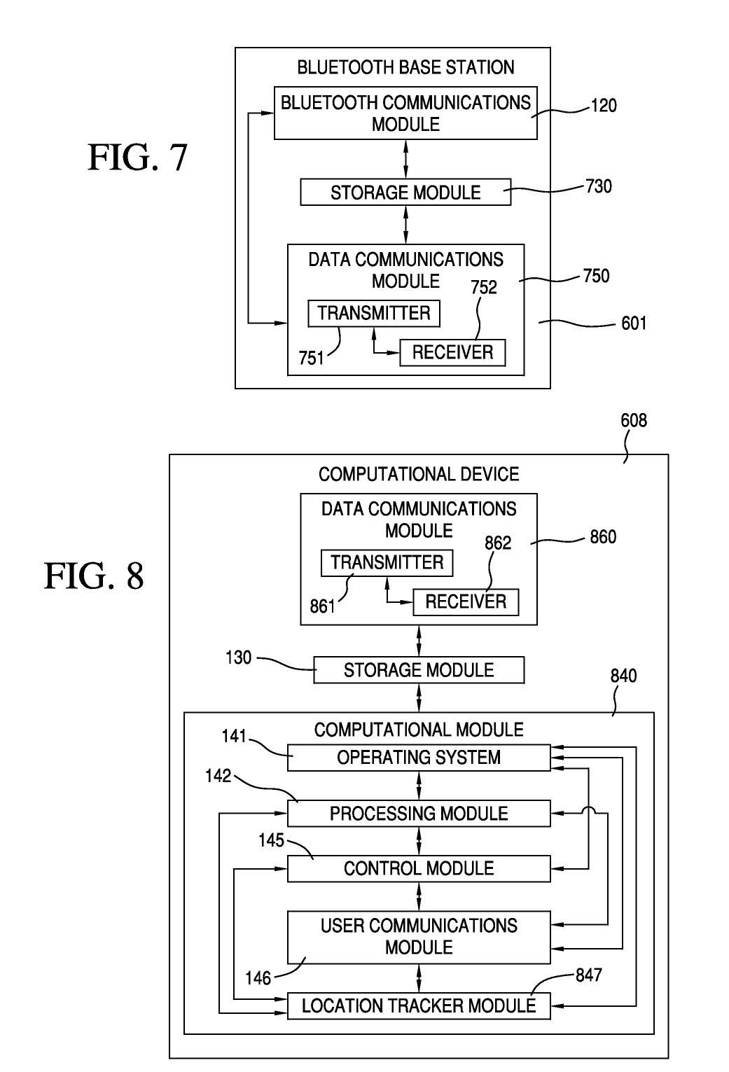

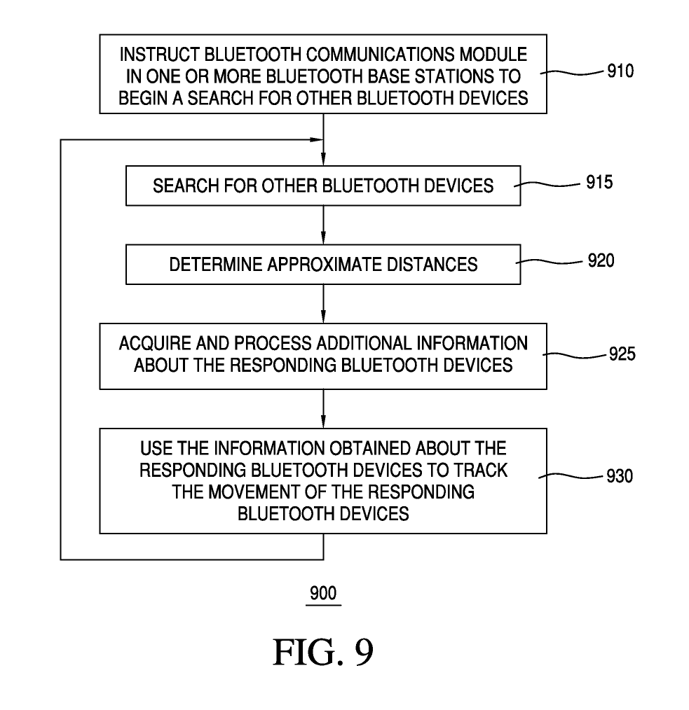

FIG. 7 illustrates a block diagram of Bluetooth base station 601, according to the second embodiment. FIG. 8 illustrates a block diagram of a computational device 608, according to the second embodiment. In various embodiments, Bluetooth base stations 604, 605, 606, and 607 (FIG. 6) can be similar or identical to Bluetooth base station 601.

In many embodiments, Bluetooth base station 601 can include: (a) Bluetooth communications module 120; (b) a storage module 730; and (c) a data communication module 750 with a transmitter 751 and a receiver 752. In some examples, Bluetooth communications module 120 can communicate one or more responses to a service discovery request to data communications module 750.

In some examples, transmitter 751 can be a wireless transmitter, and receiver 752 can be a wireless receiver. In some examples, data can be transmitted by transmitter 751 and data received by receiver 752 using WI-FI (wireless fidelity) or the IEEE (Institute of Electrical and Electronics Engineers) 802.11 wireless protocol. In further examples, the data can be transmitted and received via a Zigbee (802.15.4), Z-Wave, or a proprietary wireless standard. In other examples, transmitter 751 can transmit and receiver 752 can receive data using a cellular or wired connection.

Computational device 608 can include: (a) storage module 130; (b) a computational module 840; and (c) a data communications module 860 with transmitter 861 and receiver 862. Computational device 608 can be configured to receive information regarding one or more locations of Bluetooth devices 102 and 103 (FIG. 6) from Bluetooth base stations 601, 604, 605, 606, and 607 (FIG. 6).

Computational module 840 can be configured to run on one or more processors of one or more computer systems. Computational module 840 can include: (a) operating system 141; (b) processing module 142; (c) control module 145; (d) user communications module 146; and (e) a flow analysis or location tracker module 847.

Location tracker module 847 can be configured to receive the locations of

Bluetooth devices 102 and 103 from processing module 142. Location tracker module 847 can then determine a path in the structure of Bluetooth devices 102 and 103 at least in part based on the information regarding the one or more locations of Bluetooth devices 102 and 103.

Data communications module 860 can be configured to transmit and receive data from Bluetooth base stations 601, 604, 605, 606, and 607 (FIG. 6). In some examples, transmitter 861 can be a wireless transmitter, and receiver 862 can be a wireless receiver. In some examples, data can be transmitted by transmitter 861 and data received by receiver 862 using WI-FI or the IEEE 802.11 wireless protocol. In further examples, the data can be transmitted and received via a Zigbee (802.15.4), Z-Wave, or a proprietary wireless standard. In other examples, transmitter 861 can transmit and receiver 862 can receive data using a cellular or wired connection.

FIG. 9 illustrates a flow chart for an embodiment of a method 900 of interacting with one or more Bluetooth devices, according to the second embodiment. In some examples, method 900 can concern a method of tracking two or more Bluetooth devices. Method 900 is merely exemplary and is not limited to the embodiments presented herein. Method 900 can be employed in many different embodiments or examples not specifically depicted or described herein. In some embodiments, the activities, the procedures, and/or the processes of method 900 can be performed in the order presented. In other embodiments, the activities, the procedures, and/or the processes of the method 900 can be performed in any other suitable order. In still other embodiments, one or more of the activities, the procedures, and/or the processes in method 900 can be combined or skipped.

Referring to FIG. 9, method 900 includes an activity 910 of instructing a

Bluetooth communications module in one or more Bluetooth base stations to begin a search for other Bluetooth devices. In some examples, control module 145 of computational device 608 (FIG. 8) can instruct Bluetooth base stations 601, 604, 605, 606, and 607 (FIG. 6) to begin transmitting service discovery requests. In some examples, data communications module 860 (FIG. 8) can transmit the instructions to Bluetooth base stations 601, 604, 605, 606, and 607.

Method 900 in FIG. 9 continues with an activity 915 of searching for other

Bluetooth devices. In some examples, each of Bluetooth base stations 601, 604, 605, 606, and 607 (FIG. 6) can search for other Bluetooth devices. In various embodiments, each of the searches can be similar or identical to the search of activity 215 of FIG. 2.

Next, method 900 of FIG. 9 includes the activity 920 of determining an approximate distance for each of the responding Bluetooth devices. In many examples, Bluetooth base stations 601, 604, 605, 606, and 607 (FIG. 6) can communicate the trip times to computational device 608 (FIG. 6) but otherwise, activity 920 can be similar or identical to activity 220 of FIG. 2.

Method 900 of FIG. 9 continues with an activity 925 of acquiring and processing additional information about the responding Bluetooth devices. In some examples, control module 145 of computational device 608 (FIG. 8) can communicate to each of Bluetooth base stations 601, 604, 605, 606, and 607 (FIG. 6) if more information is needed from that particular Bluetooth base station after receiving information about a responding Bluetooth device from that particular Bluetooth base station. Otherwise, activity 925 can be similar or identical to activity 225 of FIG. 2.

The next activity in method 900 of FIG. 9 is an activity 930 of using the information obtained about the responding Bluetooth devices to track the movement of the responding Bluetooth devices. In some examples, the information about the responding Bluetooth device(s) can be used to track the location of the responding Bluetooth devices in a structure or an area.

For example, referring to FIG. 6, proximity detection system 600 allows tracking of Bluetooth devices 102 and 103 as Bluetooth devices 102 and 103 move through structure 690. In the example shown in FIG. 6, Bluetooth device 102 is located within the range of both Bluetooth base station 601 and Bluetooth base station 607. Accordingly, computational device 608 can determine the approximate location of Bluetooth device 102 in structure 690, knowing the locations of Bluetooth base stations 601, 604, 605, 606, and 607 in structure 690. As Bluetooth device 102 moves around structure 690, Bluetooth device 102 will move in and out of ranges of Bluetooth base stations 601, 604, 605, 606, and 607. If each of Bluetooth base stations 601, 604, 605, 606, and 607 communicate to computational device 608 when Bluetooth device 102 is within its range, computational device 608 can track the movement of Bluetooth device 102 through structure 690.

In many examples, Bluetooth device 102 can be a cellular telephone with Bluetooth capacity (or a Bluetooth headset). Generally, people carry their cellular telephone or Bluetooth headset with them. Thus, tracking the location of a Bluetooth device can be a proxy for tracking a location of a person. In the same or different example, tracking of a Bluetooth device can be used to determine who is in a certain room or area if a specific person is associated with a specific Bluetooth device. For example, attendance of a meeting or a class can be taken by determining what Bluetooth devices are located within a room or a specific area.

If structure 690 were a store, tracking movement of Bluetooth devices 102 and 103 around structure 690 would provide valuable information about the path of movement of the people carrying Bluetooth devices 102 and 103 through structure 690 and could be used to provide targeted advertising and/or coupons to the people.

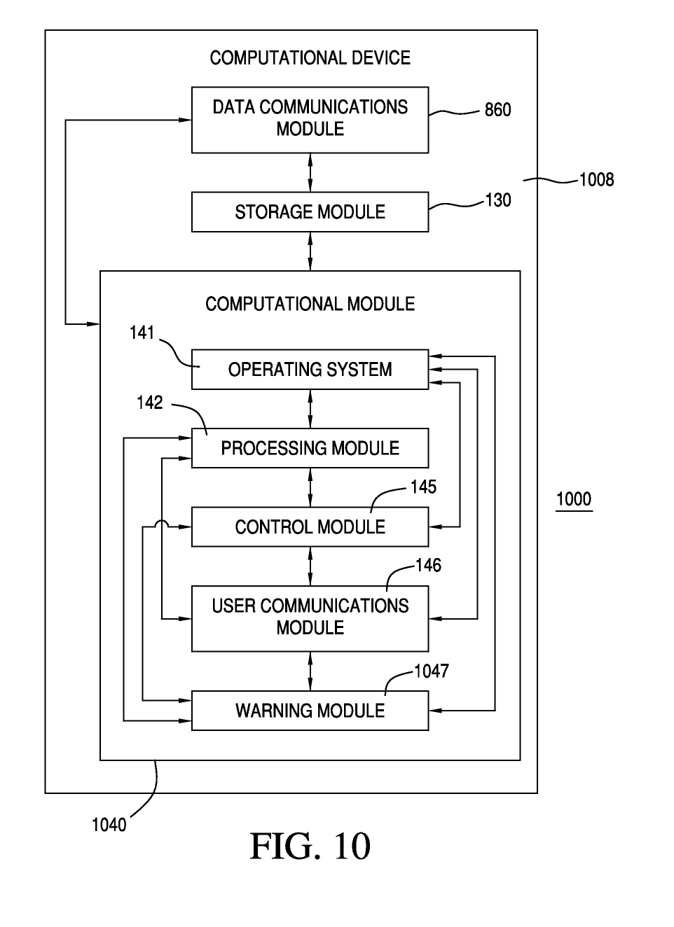

FIG. 10 illustrates a block diagram of a computational device 1008 of a proximity detection system 1000 for interacting with exemplary Bluetooth devices 102 and 103 (FIGS. 1 and 6), according to a third embodiment. Proximity detection system 1000 and computational device 1008 are merely exemplary and are not limited to the embodiments presented herein. Proximity detection system 1000 and computational device 1008 can be employed in many different embodiments or examples not specifically depicted or described herein. In various embodiments, proximity detection system 1000 can be similar or identical to proximity detection system 600 of FIG. 6 except that computational device 608 (FIG. 7) is replaced with computational device 1008.

Referring to FIG. 10, computational device 1008 can include: (a) a storage module 130; (b) a computational module 1040; and (c) data communications module 860. Computational device 1008 can be configured to receive information regarding one or more locations of Bluetooth devices 102 and 103 from Bluetooth base stations 601, 604, 605, 606, and 607 (FIG. 6).

Computational module 1040 can be configured to run on one or more processors of one or more computer systems. Computational module 1040 can include: (a) operating system 141; (b) processing module 142; (c) control module 145; (d) user communications module 146; and (e) a warning module 1047.

Warning module 1047 can be configured to receive the locations of Bluetooth devices 102 and 103 from processing module 142. Warning module 1047 can be configured to determine whether the one or more of Bluetooth device 102 and/or 103 are permitted at their current locations. In some examples, storage module 130 can store information regarding the permitted locations of Bluetooth devices 102 and 103. Accordingly, in some embodiments, proximity detection system 1000 can act as a security system or a pet, child, or baby tracking system.

For example, referring to FIG. 6, a person carrying Bluetooth device 102 might not be authorized to enter the room in which Bluetooth base station 606 is located. Thus, if warning module 1047 (FIG. 10) is notified that Bluetooth device 102 is located at Bluetooth base station 606, warning module 1047 can notify the appropriate security personnel to handle the unauthorized access.

In another example, a Bluetooth device can be attached to every newborn baby in a hospital (e.g., using a bracelet around their foot or arm). The hospital can install Bluetooth base stations around the hospital (or at least around all the exits of a maternity ward) to track the location of the newborns. If one of the Bluetooth devices attached to a newborn baby leaves the maternity ward or the hospital, without authorization, hospital security can be alerted. The Bluetooth device also can work as an indentifying tag for the newborn babies because of their unique Bluetooth device addresses.

In further examples, a Bluetooth device can be attached to a child, and the child's location in structure 690 can be tracked. If the child tries to leave structure 690 or enter a restricted area of structure 690, the appropriate personnel (e.g., a parent or guardian) can be notified by warning module 1047.

In still another embodiment, a Bluetooth device can be attached to an object (e.g., jewelry, a jewelry box, a painting, a safe, a valuable piece of equipment), and the object's location in structure 690 can be tracked. If the object is moved from structure 690 (or from a portion of structure 690) or even, if the object is moved from it current location, the appropriate personnel (e.g., security personnel and/or the police) can be notified by warning module 1047.

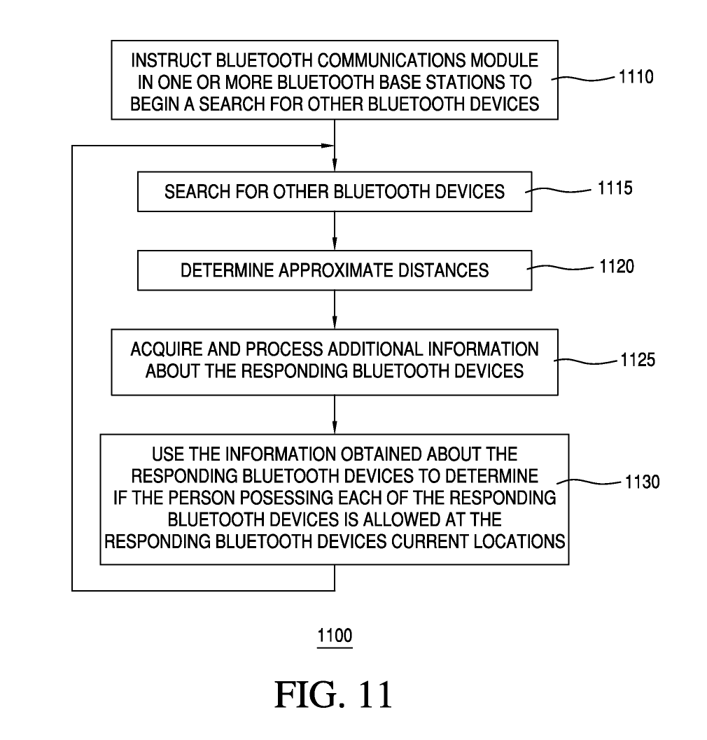

FIG. 11 illustrates a flow chart for an embodiment of a method 1100 of interacting with one or more Bluetooth devices, according to the third embodiment. In some examples, method 1100 can concern a method of determining if the person carrying of a Bluetooth device is allowed at his/her current location. Method 1100 is merely exemplary and is not limited to the embodiments presented herein. Method 1100 can be employed in many different embodiments or examples not specifically depicted or described herein. In some embodiments, the activities, the procedures, and/or the processes of method 1100 can be performed in the order presented. In other embodiments, the activities, the procedures, and/or the processes of the method 1100 can be performed in any other suitable order. In still other embodiments, one or more of the activities, the procedures, and/or the processes in method 1100 can be combined or skipped.

Referring to FIG. 11, method 1100 includes an activity 1110 of instructing a Bluetooth communications module in one or more Bluetooth base stations to begin a search for other Bluetooth devices. In some examples, control module 145 of computational device 1008 (FIG. 10) can instruct one or more Bluetooth base stations to begin transmitting the one or more service discovery requests. Activity 1110 can be similar or identical to activity 210 and/or 910 of FIGS. 2 and 9, respectively.

Method 1100 in FIG. 11 continues with an activity 1115 of searching for other Bluetooth devices. In various embodiments, each of the searches can be similar or identical to the search of activity 215 and/or 915 of FIGS. 2 and 9, respectively.

Next, method 1100 of FIG. 11 includes the activity 1120 of determining an approximate distance for each of the responding Bluetooth devices. Activity 1120 can be similar or identical to activity 220 and/or 920 of FIGS. 2 and 9, respectively.

Method 1100 of FIG. 11 continues with an activity 1125 of acquiring and processing additional information about the responding Bluetooth devices. In some examples, control module 145 of computational device 1008 (FIG. 10) can communicate to the one or more Bluetooth base stations if more information is needed, but otherwise, activity 1125 can be similar or identical to activity 225 and/or 925 of FIGS. 2 and 9.

The next activity in method 1100 is an activity 1130 of using the information obtained about the responding Bluetooth devices to determine if the person possessing each of the responding Bluetooth devices is allowed at the responding Bluetooth devices' current locations. In some examples, the information about the responding Bluetooth device(s) can be used to track the location of the responding Bluetooth devices and determine whether the person carrying the Bluetooth device or the person to which the Bluetooth device is attached is allowed at the current location of the Bluetooth device. In various examples, a warning module can determine whether the responding Bluetooth devices are permitted at their current locations based on information regarding the permitted locations of the responding Bluetooth devices that is stored in a storage device (e.g., storage module 130 of FIG. 10).

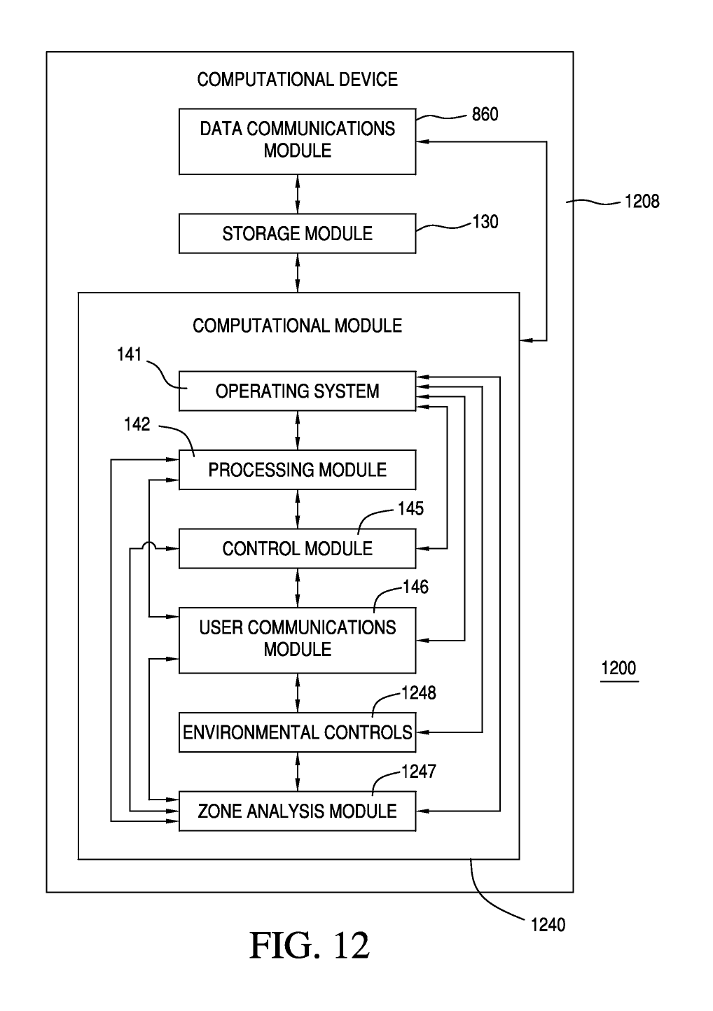

Turning to another embodiment, FIG. 12 illustrates a block diagram of a computational device 1208 of a proximity detection system 1200 for interacting with exemplary Bluetooth devices 102 and 103, according to a fourth embodiment. Proximity detection system 1200 and computational device 1208 are merely exemplary and are not limited to the embodiments presented herein. Proximity detection system 1200 and computational device 1208 can be employed in many different embodiments or examples not specifically depicted or described herein. In various embodiments, proximity detection system 1200 can be similar or identical to proximity detection system 600 of FIG. 6, except that computational device 608 is replaced with computational device 1208.

Computational device 1208 can include: (a) storage module 130; (b) a computational module 1240; and (c) data communications module 860. Computational device 1208 can be configured to receive information regarding one or more locations of Bluetooth devices 102 and 103 from Bluetooth base stations 601, 604, 605, 606, and 607 (FIG. 6).

Computational module 1240 can be configured to run on the one or more processors of one or more computer systems. Computational module 1240 can include: (a) operating system 141; (b) processing module 142; (c) control module 145; (d) user communications module 146; (e) one or more environmental controls 1248; and (f) a zone analysis module 1247.

In some examples, a structure (e.g., structure 690 of FIG. 6) can be divided into two or more zones. In one example, each room of a structure is a separate zone. In another example, a structure can be divided into two or more substantially equal regions, and each region can be a zone. Environmental controls 1248 can be used to control one or more elements of the environment in each zone of the structure. For example, environmental controls 1248 can be used to turn-on and turn-off the lights or other electrical devices in a zone. In the same or different example, environmental controls 1248 can be used to adjust the heating and cooling (e.g., the temperature) in a zone.

In the same or different embodiment, the information regarding the distance from the Bluetooth base station can be used to dynamically change one or more elements of the environment. That is, the environmental element can be adjusted (beyond just toggling the electrical power on and off) as the distance from the Bluetooth base station changes. For example, environmental controls 1248 can change the volume of the sound from a stereo system as the distance between a Bluetooth device and the Bluetooth base station and/or the stereo system changes. In various examples, when the Bluetooth device moves closer to the Bluetooth base station or the stereo system, the volume of the sound from a stereo system can be decreased by environmental controls 1248. When the Bluetooth device moves farther away from the Bluetooth base station or the stereo system, the volume of the sound from a stereo system can be increased by environmental controls 1248. Similarly, a speed of a fan or a brightness of lights can be dynamically changed as the distance between the Bluetooth device and the Bluetooth base station (or the electrical devices) changes.

Zone analysis module 1247 can be configured to communicate to one or more environmental controls 1248 to change one or more elements of the environment in the zone around Bluetooth devices 102 and 103 when Bluetooth devices 102 and 103 are at, entering, and/or leave a specific zone. For example, zone analysis module 1247 can be configured to communicate to the one or more environmental controls to toggle the electrical power to one or more lights proximate to Bluetooth devices 102 and/or 103, forward telephone calls from a cellular telephone to a land-based telephone, or adjust a temperature of a zone proximate to Bluetooth devices 102 and/or 103.

In some examples, proximity detection system 1200 can be part of a home security or other control system. In these examples, computational device 1208 can be programmed to respond in a certain way when a specific person enters or leaves a zone in a structure. This person can be linked to one or more Bluetooth devices, and zone analysis module 1247 (FIG. 12) can determine which person is linked to which Bluetooth device and how to change the environment in the zone when the specific person enters or leaves a zone.

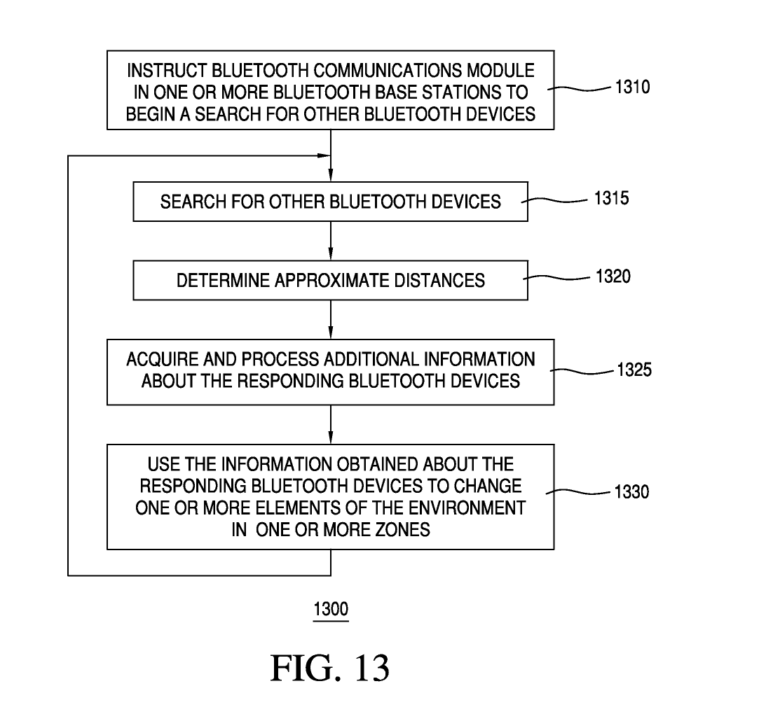

FIG. 13 illustrates a flow chart for an embodiment of a method 1300 of interacting with one or more Bluetooth devices, according to the fourth embodiment. In some examples, method 1300 can concern a method of changing one or more elements of the environment in one or more zones of a structure. Method 1300 is merely exemplary and is not limited to the embodiments presented herein. Method 1300 can be employed in many different embodiments or examples not specifically depicted or described herein. In some embodiments, the activities, the procedures, and/or the processes of method 1300 can be performed in the order presented. In other embodiments, the activities, the procedures, and/or the processes of the method 1300 can be performed in any other suitable order. In still other embodiments, one or more of the activities, the procedures, and/or the processes in method 1300 can be combined or skipped.

Referring to FIG. 13, method 1300 includes an activity 1310 of instructing a Bluetooth communications module in one or more Bluetooth base stations to begin a search for other Bluetooth devices. In some examples, control module 145 of computational device 1208 (FIG. 12) can instruct one or more Bluetooth base stations to begin transmitting the one or more service discovery requests. Activity 1310 can be similar or identical to activity 210, 910, and/or 1110 of FIGS. 2, 9, and 11, respectively.

Method 1300 in FIG. 13 continues with an activity 1315 of searching for other Bluetooth devices. In various embodiments, each of the searches can be similar or identical to the search of activity 215, 915, and/or 1115 of FIGS. 2, 9, and 11, respectively.

Next, method 1300 of FIG. 13 includes an activity 1320 of determining an approximate distance for each of the responding Bluetooth devices. Activity 1320 can be similar or identical to activity 220, 920, and/or 1120 of FIGS. 2, 9, and 11, respectively.

Method 1300 of FIG. 13 continues with an activity 1325 of acquiring and processing additional information about the responding Bluetooth devices. In some examples, control module 145 of computational device 1208 (FIG. 12) can communicate to the one or more Bluetooth base stations if more information is needed but otherwise, activity 1325 can be similar or identical to activity 225, 925, and/or 1125 of FIGS. 2, 9, and 11, respectively.

The next activity in method 1300 is an activity 1330 of using the information obtained about the responding Bluetooth devices to change one or more elements of the environment in one or more zones. In some examples, zone analysis module 1247 (FIG. 12) can determine when Bluetooth devices 102 and 103 (and the person possessing Bluetooth devices 102 and 103) leaves or enters a zone. Zone analysis module 1247 (FIG. 12) can instruct environmental controls 1248 (FIG. 12) to change one or more elements in the zones (e.g., toggle the electrical power to the lights in the zone, toggle the electrical power to one or more electrical devices, adjust the temperature in the zone). Also, zone analysis module 1247 (FIG. 12) can determine when Bluetooth devices 102 and 103 (and the person possessing Bluetooth devices 102 and 103) position in a zone changes. Zone analysis module 1247 (FIG. 12) can instruct environmental controls 1248 (FIG. 12) to dynamically adjust one or more elements in the zone as the position changes (e.g., dynamically adjust the volume of a stereo system, the brightness of the lights, or the speed of a fan).

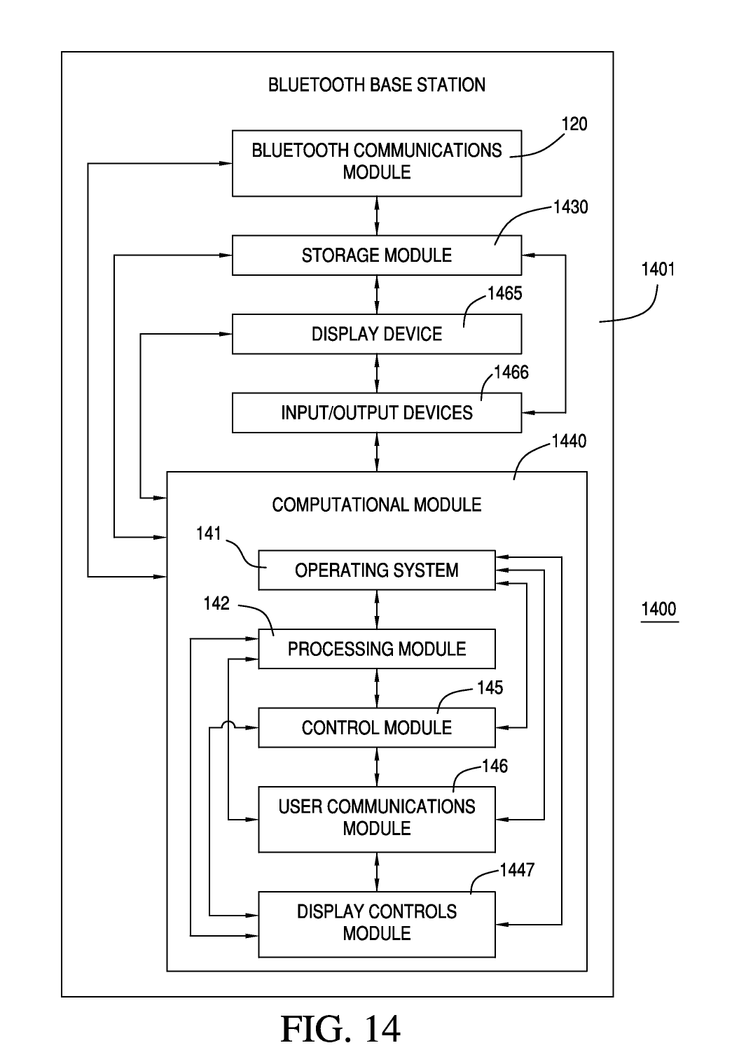

FIG. 14 illustrates a block diagram of a Bluetooth base station 1401 of a proximity detection system 1400 for interacting with exemplary Bluetooth devices 102 and 103 (FIGS. 1 and 6), according to a fifth embodiment. Proximity detection system 1400 and Bluetooth base station 1401 are merely exemplary and are not limited to the embodiments presented herein. Proximity detection system 1400 and Bluetooth base station 1401 can be employed in many different embodiments or examples not specifically depicted or described herein.

Referring to FIG. 14, in some examples, Bluetooth base station 1401 can include: (a) a Bluetooth communications module 120; (b) a storage module 1430; (c) a computational module 1440; (d) a display device 1465; and (e) one or more input/output devices 1466.

Display device 1465 can be electrically coupled to computational module 1440 and configured to display one or more display items to the people possessing Bluetooth devices 102 and/or 103. In some examples, display device can be a television (e.g., a flat screen television) or a touch screen device. In the same or different examples, the display device can include an audio system, which can include one or more speakers.

In some examples, the one or more display items can be advertisements for specific products, information on related products suggested or recommended for use with Bluetooth device 102 and/or 103 (or other products previously visited within a store), or information about products located in the vicinity of display device 1465.

Input/output devices 1466 can be a mouse or pointing device, a keyboard, or other input devices. The input devices can be used to provide input to display device 1465 from one or more people (e.g., the person possessing Bluetooth device 102 or 103). Input/output devices 1467 can also include a printer or other output devices. In one example, the printer can be used to print out coupons or information for a user or viewer of display device 1465.

Computational module 1440 can be configured to run on one or more processors of one or more computer systems. Computational module 1440 can include: (a) operating system 141; (b) processing module 142; (c) control module 145; (d) user communications module 146; and (e) display controls module 1447.

Display controls module 1447 can be configured to determine the one or more display items to be displayed on display device 1465. In some examples, display controls module 1447 can determine what to display on display device 1465 least in part based on the approximate distance between Bluetooth base station 1401 and Bluetooth devices 102 and 103 (FIGS. 1 and 6). In the same or different example, display controls module 1447 can further use the Bluetooth device type to determine the one or more display items. Display controls module 1447 can be further configured to communicate the one or more display items to the display device 1465.

In some examples, system 1400 can be used to provide contextual advertising to shopper in a store or people walking through a public structure. In other examples, system 1400 can be used to provide contextual advertising or information in a home setting. For example, different advertisements or information can be displayed on display device 1465 when different family members or residents of a home are near display device 1465.

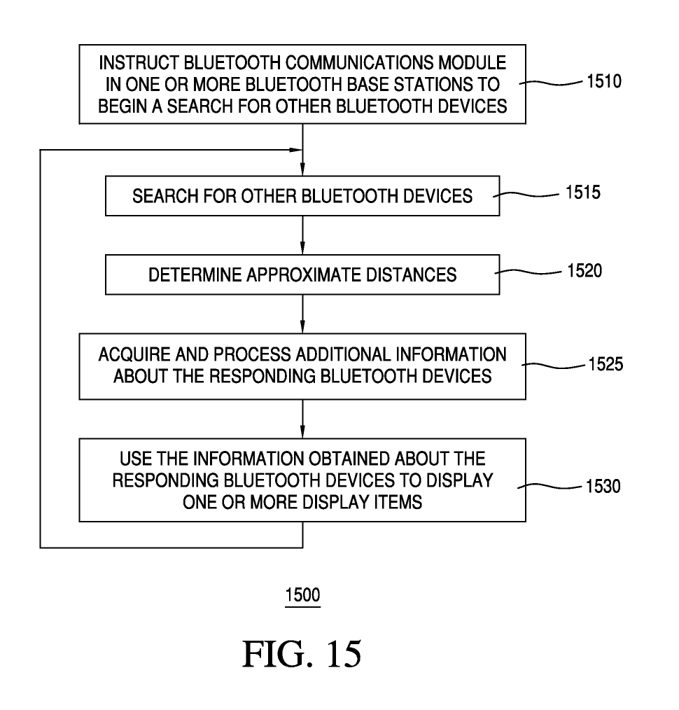

FIG. 15 illustrates a flow chart for an embodiment of a method 1500 of interacting with one or more Bluetooth devices, according to the fifth embodiment. In some examples, method 1500 can concern a method of displaying one or more display items or a method of determining one or more items to display. Method 1500 is merely exemplary and is not limited to the embodiments presented herein. Method 1500 can be employed in many different embodiments or examples not specifically depicted or described herein. In some embodiments, the activities, the procedures, and/or the processes of method 1500 can be performed in the order presented. In other embodiments, the activities, the procedures, and/or the processes of the method 1500 can be performed in any other suitable order. In still other embodiments, one or more of the activities, the procedures, and/or the processes in method 1500 can be combined or skipped.

Referring to FIG. 15, method 1500 includes an activity 1510 of instructing a Bluetooth communications module in one or more Bluetooth base stations to begin a search for other Bluetooth devices. In some examples, control module 145 (FIG. 14) can instruct one or more Bluetooth base stations to begin transmitting the one or more service discovery requests. Activity 1510 can be similar or identical to activity 210, 910, 1110, and/or 1310 of FIGS. 2, 9, 11, and 13, respectively.

Method 1500 in FIG. 15 continues with an activity 1515 of searching for other Bluetooth devices. In various embodiments, each of the searches can be similar or identical to the search of activity 215, 915, 1115, and/or 1315 of FIGS. 2, 9, 11, and 13, respectively.

Next, method 1500 of FIG. 15 includes the activity 1520 of determining an approximate distance for each of the responding Bluetooth devices. Activity 1520 can be similar or identical to activity 220, 920, 1120, and/or 1320 of FIGS. 2, 9, 11, and 13, respectively.

Method 1500 of FIG. 15 continues with an activity 1525 of acquiring and processing additional information about the responding Bluetooth devices. In some examples, control module 145 of Bluetooth base station 1401 (FIG. 14) can communicate to the one or more Bluetooth base stations if more information is needed, but otherwise, activity 1525 can be similar or identical to activity 225, 925, 1125, and/or 1325 of FIGS. 2, 9, 11, and 13, respectively.

The next activity in method 1500 is an activity 1530 of use the information obtained about the responding Bluetooth devices to display one or more display items. In some examples, display controls module 1447 (FIG. 14) can determine the one or more display items to be displayed on display device 1465 (FIG. 14) and display device 1465 can display the one or more display items.

In some examples, the items to display can be determine at least in part based on the approximate distance between the Bluetooth base station and the responding Bluetooth device. In the same or different example, the items to display can be determine at least in part based on Bluetooth device type of the responding Bluetooth device.

In further embodiments, a proximity detection system can include two or more of a location tracker module 847 (FIG. 8), warning module 1047 (FIG. 10), zone analysis module 1248 (FIG. 12), environmental controls 1248 (FIG. 12), display controls module 1447 (FIG. 14), input/output devices 1466 (FIG. 14), and/or display device 1465 (FIG. 14). Similarly, according to further embodiments, a method of using or interacting with one or more Bluetooth devices can include two or more of activity 230 (FIG. 2), activity 930 (FIG. 9), activity 1130 (FIG. 11), activity 1330 (FIG. 13), and/or activity 1530 (FIG. 15).

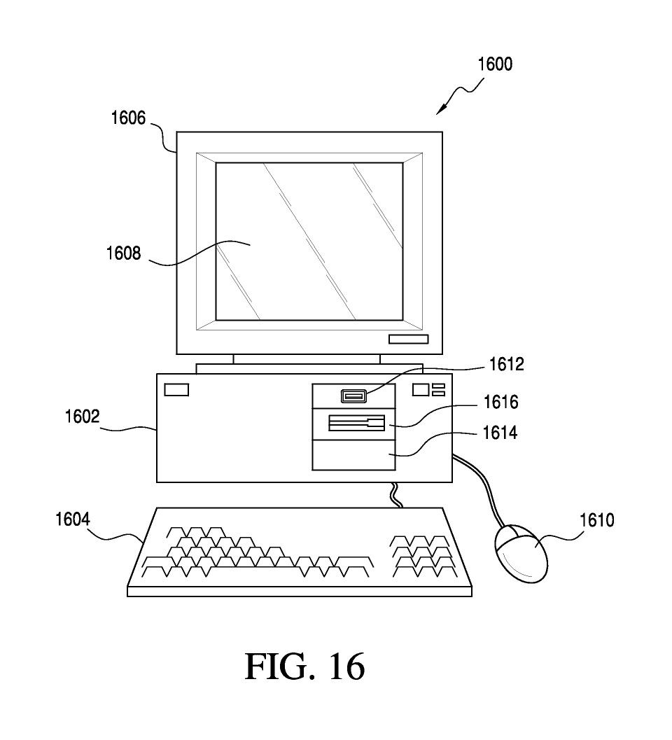

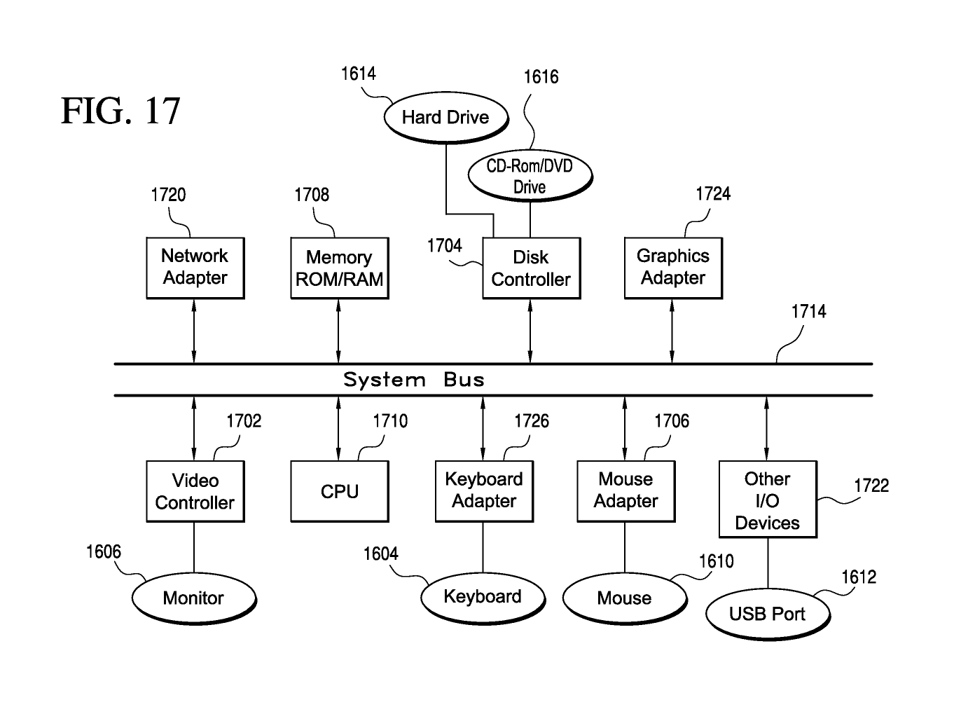

FIG. 16 illustrates an exemplary embodiment of a computer system 1600 that is suitable for implementing an embodiment of at least a portion of proximity detection system 100 (FIG. 1). Computer system 1600 includes a chassis 1602 containing one or more circuit boards (not shown), a USB (universal serial bus) port 1612, a Compact Disc Read-Only Memory (CD-ROM) and/or Digital Video Disc (DVD) drive 1616, and a hard drive 1614. A representative block diagram of the elements included on the circuit boards inside chassis 1602 is shown in FIG. 17. A central processing unit (CPU) 1710 in FIG. 17 is coupled to a system bus 1714 in FIG. 17. In various embodiments, the architecture of CPU 1710 can be compliant with any of a variety of commercially distributed architecture families including the RS/6000 family, the Motorola 68000 family, or the Intel x86 family.

System bus 1714 also is coupled to memory 1708 that includes both read only memory (ROM) and random access memory (RAM). Non-volatile portions of memory 1708 or the ROM can be encoded with a boot code sequence suitable for restoring computer system 1600 (FIG. 16) to a functional state after a system reset. In addition, memory 1708 can include microcode such as a Basic Input-Output System (BIOS). In some examples, storage module 130 (FIG. 1) and/or storage module 1430 (FIG. 14) can include memory 1708, USB port 1612, hard drive 1614, and/or CD-ROM or DVD drive 1616.

In the depicted embodiment of FIG. 17, various I/O devices such as a disk controller 1704, a graphics adapter 1724, a video controller 1702, a keyboard adapter 1726, a mouse adapter 1706, a network adapter 1720, and other I/O device adapter 1722 can be coupled to system bus 1714. Keyboard adapter 1726, I/O device adapter 1722, and mouse adapter 1706 are coupled to a keyboard 1604 (FIGS. 16 and 17), USB port 1612 (FIGS. 16 and 17), and a mouse 1610 (FIGS. 16 and 17), respectively, of computer system 1600 (FIG. 16). While graphics adapter 1724 and video controller 1702 are indicated as distinct units in FIG. 17, video controller 1702 can be integrated into graphics adapter 1724, or vice versa, in other embodiments. Video controller 1702 is suitable for refreshing a monitor 1606 (FIGS. 16 and 17) to display images on a screen 1608 (FIG. 16) of computer system 1600 (FIG. 16). Disk controller 1704 can control hard drive 1614 (FIGS. 16 and 17), and CD-ROM or DVD drive 1616 (FIGS. 16 and 17). In other embodiments, distinct units can be used to control each of these devices separately.

Although many other components of computer system 1600 (FIG. 9) are not shown, such components and their interconnection are well known to those of ordinary skill in the art. Accordingly, further details concerning the construction and composition of computer system 1600 and the circuit boards inside chassis 1602 (FIG. 16) need not be discussed herein.

When computer system 1600 in FIG. 16 is running, program instructions stored on a USB drive in USB port 1612, on a CD-ROM or DVD in CD-ROM and/or DVD drive 1616, on hard drive 1614, or in memory 1708 (FIG. 17) are executed by CPU 1710 (FIG. 17). A portion of the program instructions, stored on these devices, can be suitable for carrying out methods 200, 900, 1100, 1300, and 1500 of FIGS. 2, 9, 11, 13, and 15, respectively.

Several feasibility experiments were performed as part of the development of embodiments of proximity detection systems 100, 600, 1000, 1200, and 1400 of FIGS. 1, 6, 10, 12, and 14, respectively, and methods 200, 900, 1100, 1300, and 1500 of FIGS. 2, 9, 11, 13, and 15, respectively. In this section, results are presented from these experiments.

In these experiments, the receiving Bluetooth device tag (e.g., Bluetooth device 102 and 103 of FIG. 1) can be ABS (acrylonitrile butadiene styrene) plastic encased beacons that comprise a low-power CSR™ BlueCore-02 Class 2 Bluetooth RF (radio frequency) module with an integrated antenna and a 3.7 V (volt) 345 mAh (milliamp hour) ion battery. The tag can signal every minute for approximately five days with a single, two-hour charge. A buzzer and LED (limit emitting diode) on the tag can indicate when the battery is low. The tag uses a Class 2 Bluetooth module with a 10 meter range, which is sufficient for registering the levels of proximity of interest and uses much less power than the longer range Class 1 modules. The Bluetooth stack implements the Serial Port Profile (SPP) running over L2CAP (Logical Link Control and Adaptation Protocol) and RFCOMM (Radio frequency communication) for firmware programming. The Bluetooth radio in the user's beacon was reduced to −22 dB (decibels) to extend battery life and limit the maximum range at which the Bluetooth base station (e.g., a cellular phone) can detect the tag to around five to six meters. The design of the radio output and subsequent distance analysis assumed a tag placed around the neck of an average adult.

Rather than use a Received Signal Strength Indicator (RSSI), which is implemented inconsistently across mobile phones, if at all, a simpler signal strength indicator for proximity detection was implemented. In this simpler solution, the round trip time of the Service Discovery Protocol (SDP) packets can be used to estimate the distance between the tag (i.e., the Bluetooth device) and the mobile phone (i.e., Bluetooth base station). As the distance increases between the mobile phone and the tag, the link quality degrades. The lower link quality then increases the bit error rate and, thus, the number of packet retransmissions. The retransmits, in turn, increase the service discovery time. Despite the simplicity of this approach, it was more than sufficient for the desired level of granularity.

By reducing the radio output of the tag, a rough range can be set at which the bit error rates increase by a predetermined amount. After experimentation in lab settings with humans of average size, the appropriate range values were determined. A phone within arm's reach (1-2 meters)typically shows a service discovery time of about 2000-4000 ms (milliseconds), room-level distance (3-6 meters) of about 4000-7000 ms, and no returned service discovery information is interpreted as the phone being out of range or further than room level (greater than 6 meters). In practice, physical room level distance can result in fluctuating values between 4000 ms and no return service discovery information. This fluctuation is likely due to a bit error rate that is so high that the Bluetooth module times out and does not report a successful service discovery. One issue with this phenomenon is the difficulty that results in determining whether the phone is transitioning from “room level” and truly out of range or whether the phone is consistently at room level with the erroneous fluctuation described. Thus, if high rates of fluctuation (e.g., alternating with every reading) were observed over extended periods (more than five minutes), the reading was classified as room level.

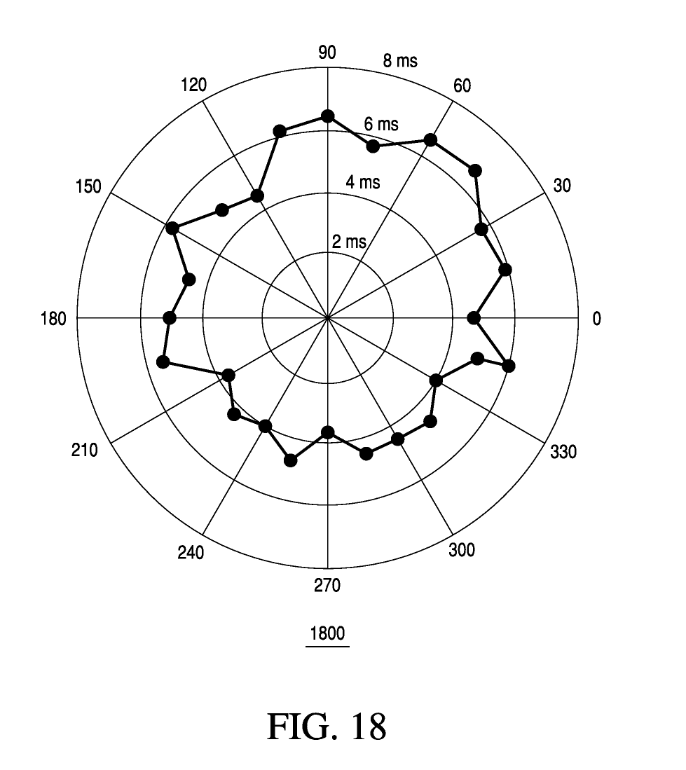

The technical evaluation consisted of three experiments. The first was a laboratory experiment that consisted of individuals wearing the Bluetooth tag around their neck on a lanyard, and round trip time readings were taken (with a mobile phone) at varying positions around the individuals. All measurements were taken at approximately the same horizontal plane. This experiment served to determine the appropriate radio detuning values and the round trip times for the three proximity levels. FIG. 18 illustrates a graph showing a plot of the maximum range of the tags at varying positions around an individual wearing the tag, according to an embodiment. As seen in the plot, the maximum range of the tag is about 1.5 fewer meters when it is behind the person wearing the tag. This phenomenon is mainly due to the person's body and clothing reflecting and absorbing the 2.4 GHz signal.

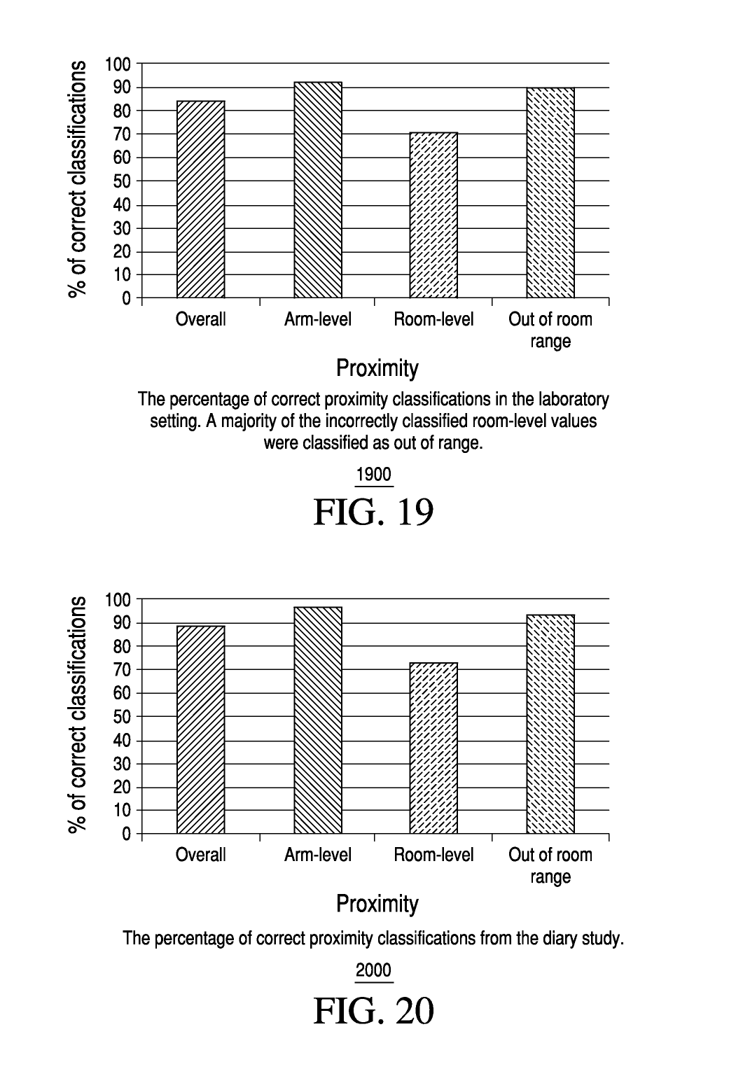

The purpose of the second experiment was to evaluate the accuracy of the three levels of prediction. The second evaluation was similar to the first one in that it consisted of an individual wearing the Bluetooth tag around his neck on a lanyard. Proximity readings were taken at varying positions around the individuals. The ground truth distance was compared to the predicted distance (arm's length, room level, or not available) at each point. In the experiment, a total of 75 positions (25 in arm's length range, 25 in room-level range, and 25 out-of-range) were selected around the individual, and at each position, ten proximity readings were taken. Thus, 750 total readings were taken. This whole process was carried out for two different individuals. FIG. 19 illustrates a graph showing the results of the overall arm's length-level, room-level, and out-of-range accuracies, according to an embodiment. Upon further investigation, many of the classification errors came from the room-level value being classified as out-of-range. This fluctuation is especially apparent near the 4-6 meter point where it is near its maximum range. As a result, during the data analysis and interview phase, care was taken to determine whether this fluctuation was due to actual room level and out-of-range transitions or if it was an incorrectly classified room-level value.

The third evaluation was to test the system in a more natural setting. The system was deployed with two individuals who were asked to keep a diary that logged each time they transitioned between one of the three levels. The diary entry included the time and the one of the three distance measures. Each participant collected approximately 50 samples in a 48-hour period. Because of the tedious nature of this investigation, this investigation was limited to the number of test samples, but still obtained enough data to provide some insights in its performance. FIG. 20 illustrates a graph showing the results of the different levels of proximity, according to an embodiment. The results are similar to the laboratory study despite the limited number of samples. Also similar to the laboratory experiments was that the room-level proximity classification has the lowest performance and was mainly due to incidents incorrectly being classified as out-of-range.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities in methods 200, 900, 1100, 1300, and 1500 of FIGS. 2, 9, 11, 13, and 15, respectively, and the procedures of activities 215, 220, 225 of FIGS. 3, 4, and 5, respectively, may be comprised of many different activities and procedures and may be performed by many different modules and in many different orders, and that any element of FIG. 1, 7, 8, 10, 12, or 14 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus for determining a proximity of one or more first Bluetooth devices, the apparatus comprising:
at least one Bluetooth base station comprising:
a Bluetooth transmitter configured to transmit one or more service discovery requests to the one or more first Bluetooth devices; and
a Bluetooth receiver configured to receive one or more responses from the one or more first Bluetooth devices to the one or more service discovery requests; and
a computational module configured to run on one or more processors and further configured to determine one or more approximate distances between the at least one Bluetooth base station and the one or more first Bluetooth devices based on the one or more responses from the one or more first Bluetooth devices.

2. The apparatus of claim 1, wherein:
the computational module comprises:
a timing module configured to determine one or more first amounts of time between transmitting the one or more service discovery requests and receiving the one or more responses to the one or more service discovery requests; and
a range module configured to determine the one or more approximate distances between the at least one Bluetooth base station and the one or more first Bluetooth devices at least in part using the one or more first amounts of time.

3. The apparatus of claim 1, wherein:
the Bluetooth transmitter is further configured to transmit the one or more service discovery requests without the at least one Bluetooth base station previously pairing with the one or more first Bluetooth devices; and
the Bluetooth receiver is further configured to receive the one or more responses from the one or more first Bluetooth devices to the one or more service discovery requests without the at least one Bluetooth base station previously pairing with the one or more first Bluetooth devices.

4. The apparatus of claim 1, wherein:
the Bluetooth receiver is further configured to receive one or more Bluetooth device addresses from the one or more first Bluetooth devices as part of the one or more responses; and
the computational module is further configured to use the one or more Bluetooth device addresses of the one or more first Bluetooth devices to determine a device type of the one or more first Bluetooth devices.

5. The apparatus of claim 1, wherein:
the Bluetooth transmitter is further configured to request a list of offered services from at least one of the one or more first Bluetooth devices;
the Bluetooth receiver is further configured to receive the list of offered services from the at least one of the one or more first Bluetooth devices; and
the computational module is further configured to use the list of offered services to determine a device type of the at least one of the one or more first Bluetooth devices.

6. The apparatus of claim 1, further comprising:
at least one display device electrically coupled to the computational module and configured to display one or more display items to at least a person who possesses a first one of the one or more first Bluetooth devices,
wherein:
the computation module is further configured to determine the one or more display items at least in part based on a first distance between the Bluetooth base station and the first one of the one or more first Bluetooth devices;
the computation module is further configured to communicate the one or more display items to the at least one display device; and
the one or more approximate distances comprise the first distance.

7. The apparatus of claim 6, wherein:
the Bluetooth receiver is further configured to receive a Bluetooth device address from the first one of the one or more first Bluetooth devices;
the computational module is further configured to use the Bluetooth device address of the first one of the one or more Bluetooth devices to determine a device type of the first one of the one or more Bluetooth devices; and
the computation module is further configured to determine the one or more display items at least in part based on the first distance and the device type of the first one of the one or more Bluetooth devices.

8. The apparatus of claim 6, wherein:
the Bluetooth transmitter is further configured to request a list of offered services from the first one of the one or more first Bluetooth devices;
the Bluetooth receiver is further configured to receive the list of offered services from the first one of the one or more first Bluetooth devices; and
the computational module is further configured to determine the one or more display items at least in part based on the first distance and the list of offered services.

9. The apparatus of claim 1, wherein:
the one or more first Bluetooth devices comprise a Bluetooth tag configured to couple to a set of keys.

10. The apparatus of claim 1, wherein:
two or more stations of the at least one Bluetooth base station are distributed in a structure.

11. The apparatus of claim 10, further comprising:
a flow analysis module configured to receive information regarding one or more locations of the one or more first Bluetooth devices from the two or more stations of the at least one Bluetooth base station,
wherein:
the flow analysis module is further configured to determine a path in the structure of at least a first device of the one or more first Bluetooth devices at least in part based on the information regarding the one or more locations of the one or more first Bluetooth devices.

12. The apparatus of claim 10, further comprising:
a warning module configured to receive information regarding one or more locations of the one or more first Bluetooth devices from the two or more stations of the at least one Bluetooth base station,
wherein:
the warning module is further configured to determine whether the one or more first Bluetooth devices are permitted to be proximate to the one or more locations.

13. The apparatus of claim 10, further comprising:
one or more environmental controls configured to change one or more elements of an environment at one or more locations of the one or more first Bluetooth devices; and
a zone analysis module configured to receive information regarding the one or more locations from the two or more stations of the at least one Bluetooth base station, wherein:
the zone analysis module is further configured to communicate to the one or more environmental controls to change the one or more elements of the environment at the one or more locations when the one or more first Bluetooth devices are proximate to the one or more locations.

14. The apparatus of claim 13, wherein:
the zone analysis module is further configured to communicate to the one or more environmental controls to at least one of:
toggle electrical power to one or more lights proximate to the one or more locations; or
adjust a temperature of a zone of the structure proximate to or encompassing the one or more locations.

15. The apparatus of claim 1, wherein:
the at least one Bluetooth base station further comprises the computational module.

16. The apparatus of claim 1, wherein:
the one or more first Bluetooth devices are configured such that the one or more first Bluetooth devices receive the one or more service discovery requests from the Bluetooth transmitter while the one or more first Bluetooth devices are paired to one or more second Bluetooth devices; and
the one or more first Bluetooth devices are configured such that the one or more first Bluetooth devices transmit the one or more responses to the one or more service discovery requests while the one or more first Bluetooth devices are paired to the one or more second Bluetooth devices.

17. A Bluetooth proximity detection system configured to interact with one or more first Bluetooth devices, the Bluetooth proximity detection system comprising:
one or more Bluetooth communications modules configured to exchange messages with the one or more first Bluetooth devices using the Bluetooth Service Discovery Protocol; and
one or more processing modules configured to run on one or more processors of one or more computer systems,
wherein:
the one or more Bluetooth communications modules are configured to receive one or more of the messages from the one or more first Bluetooth devices using the Bluetooth Service Discovery Protocol;
the one or more processing modules are further configured to determine one or more approximate distances between the one or more Bluetooth communications modules and the one or more first Bluetooth devices at least in part using the one or more of the messages; and
the one or more processing modules are further configured to determine a device type of the one or more first Bluetooth devices using the one or more of the messages.

18. The Bluetooth proximity detection system of claim 17, wherein:
the one or more Bluetooth communication modules are configured such that the one or more Bluetooth communications modules can exchange the messages with the one or more first Bluetooth devices while the one or more first Bluetooth devices are paired to one or more second Bluetooth devices.

19. The Bluetooth proximity detection system of claim 17, further comprising:
a location tracker module configured to run on the one or more processors of the one or more computer systems,
wherein:
the location tracker module is further configured to use the one or more approximate distances to track one or more locations of the one or more first Bluetooth devices.

20. A method of interacting with one or more first Bluetooth devices, the method comprising:
transmitting from one or more first Bluetooth base stations one or more service discovery requests to the one or more first Bluetooth devices;
receiving in the one or more first Bluetooth base stations one or more responses from the one or more first Bluetooth devices to the one or more service discovery requests;
determining one or more first times between transmitting the one or more service discovery requests and receiving the one or more responses; and
using the one or more first times to determine one or more approximate distances between the one or more first Bluetooth base stations and the one or more first Bluetooth devices.

21. The method of claim 20, further comprising:
using information obtained about the one or more first Bluetooth devices.

22. The method of claim 20, further comprising:
determining a device type of the one or more first Bluetooth devices.

23. The method of claim 20, wherein:
transmitting the one or more service discovery requests and receiving the one or more responses occur without pairing with the one or more first Bluetooth devices.

24. The method of claim 20, wherein:
determining the one or more first times comprises:
recording one or more second times when the one or more first Bluetooth base stations transmitted the one or more service discovery requests;
recording one or more third times when the one or more first Bluetooth base stations received the one or more responses; and
calculating the one or more first times using the one or more second times and the one or more third times.

25. The method of claim 20, wherein:
using the one or more first times to determine the one or more approximate distances comprises:
accessing a set of relationships between the first times and device distances to determine the one or more approximate distances between the one or more first Bluetooth base stations and the one or more first Bluetooth devices.
